(19) United States
(12) Patent Application Publication
(10) Pub. No.: US 2024/0413337 A1
(43) Pub. Date: Dec. 12, 2024

(54) Method of Preparing Cathode Slurry for Secondary Battery

(71) Applicant: GRST International Limited, Hong Kong (CN)

(72) Inventors: Kam Piu Ho, Hong Kong (CN); Hongke Qiu, Liannan Yao Autonomous County (CN)

(21) Appl. No.: 18/736,598

(22) Filed: Jun. 7, 2024

(30) Foreign Application Priority Data
Jun. 9, 2023 (CN) 202310688385.4

(51) Int. Cl. H01M 4/62; H01M 4/02; H01M 4/04; H01M 4/505; H01M 4/525

(52) U.S. Cl. CPC H01M 4/622; H01M 4/0416; H01M 4/505; H01M 4/525; H01M 4/625; H01M 2004/028

(57) ABSTRACT

The invention provides a method of preparing a cathode slurry for a secondary battery, comprising a binder material, comprising a copolymer P₁ and a copolymer P₂. Both copolymers each independently comprise a structural unit derived from a monomer containing an acid group; a structural unit derived from a monomer selected from the group consisting of an amide group-containing monomer, a hydroxyl group-containing monomer, and combinations thereof; and a structural unit derived from a monomer selected from the group consisting of a nitrile group-containing monomer, an ether group-containing monomer, an epoxy group-containing monomer, and combinations thereof. As a result of the chemical compositions of the respective copolymers and the method itself, the cathode slurry is well dispersed, and batteries made therefrom have good cycling stability.

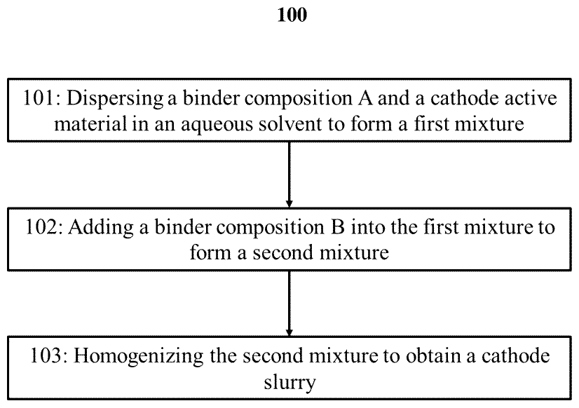

### CROSS-REFERENCE TO RELATED APPLICATIONS

This application claims the benefit of Chinese Patent Application no. 202310688385.4, filed Jun. 9, 2023, which is incorporated herein by reference in its entirety.

### FIELD OF THE INVENTION

The present invention relates to the field of batteries. In particular, this invention relates to a method of preparing a cathode slurry for a secondary battery.

### BACKGROUND OF THE INVENTION

Over the past decades, lithium-ion batteries (LIBs) have come to be widely utilized in various applications, especially consumer electronics, because of their outstanding energy density, long cycle life and high discharging capability. Due to rapid market development of electric vehicles (EV) and grid energy storage, high-performance, low-cost LIBs are currently one of the most promising options for large-scale energy storage devices.

Generally, the cathode of a lithium-ion battery comprises an electrode layer and a current collector, wherein the electrode layer comprises a cathode active material and a binder material. The cathode may additionally comprise a conductive agent. The binder material holds together the cathode components (the cathode active material, the binder material, and optionally the conductive agent) and adheres them to the current collector, and can greatly affect battery cycling stability. A common method of manufacturing the cathode is by preparing a cathode slurry that comprises the cathode components and a solvent, then coating the cathode slurry onto a metallic current collector and drying it. In the cathode slurry, it is vital that the cathode components are well dispersed in the solvent. Otherwise, local variations in the coated slurry could lead to defects in the cathode, which would negatively affect battery electrochemical performance. Accordingly, a binder material suitable for use in a cathode should both disperse well in the solvent and result in good battery cycling stability when used.

One of the most commonly used methods of producing cathode slurries uses polyvinylidene fluoride (PVDF) as the binder material. PVDF does result in good battery cycling stability when used. However, PVDF can only dissolve in some specific organic solvents, such as N-methyl-2-pyrrolidone (NMP), which is flammable and toxic. The drying process would require a recovery system to be in place to recover NMP vapors, which generates significant costs in the manufacturing process and requires a large capital investment.

Methods of producing cathode slurries which use water instead as the solvent have been explored. These methods use binder materials such as carboxymethyl cellulose (CMC) and styrene-butadiene rubber (SBR), which disperses well in water. However, SBR and CMC exhibit poor adhesion capability and battery cycling stability. In particular, SBR is not stable in high voltage environments such as the cathode of a battery, and would readily decompose during cycling.

It is worth noting that the above problems are not particular to lithium-ion batteries. Other types of batteries, such as sodium-ion batteries, may also encounter similar problems.

Accordingly, there is a need to develop a novel method to produce a cathode slurry for a secondary battery, such that the binder material disperses well in the solvent of the cathode slurry, and the binder material itself also promotes battery cycling ability.

### SUMMARY OF THE INVENTION

The aforementioned needs are met by various aspects and embodiments disclosed herein. Provided herein is a method of preparing a cathode slurry for a secondary battery, comprising the steps of:
1) dispersing a binder composition A and a cathode active material in an aqueous solvent to form a first mixture;
2) adding a binder composition B into the first mixture to form a second mixture; and
3) homogenizing the second mixture to obtain the cathode slurry;
   wherein the binder composition A comprises a copolymer P₁ and the binder composition B comprises a copolymer P₂; wherein the copolymer P₁ comprises a structural unit (a₁), a structural unit (b₁), and a structural unit (c₁); wherein the copolymer P₂ comprises a structural unit (a₂), a structural unit (b₂), and a structural unit (c₂); wherein each of the structural unit (a₁) and the structural unit (a₂) is independently derived from a monomer containing an acid group; wherein each of the structural unit (b₁) and the structural unit (b₂) is independently derived from a monomer selected from the group consisting of an amide group-containing monomer, a hydroxyl group-containing monomer, and combinations thereof; and wherein each of the structural unit (c₁) and the structural unit (c₂) is independently derived from a monomer selected from the group consisting of a nitrile group-containing monomer, an ether group-containing monomer, an epoxy group-containing monomer, and combinations thereof.

The invention as disclosed herein solves important problems relating to cathode slurries. Firstly, the binder material in the slurry is well-dispersed, reducing the risk of cathode defect formation. Secondly, the binder material in the slurry also promotes good battery cycling stability. Accordingly, when a cathode slurry produced using the method disclosed herein is used to manufacture a cathode, a battery comprising the cathode would have good electrochemical performance.

### BRIEF DESCRIPTION OF THE DRAWINGS

The sole FIGURE is a flow chart illustrating an embodiment of the method to produce a cathode slurry disclosed herein.

### DETAILED DESCRIPTION OF THE INVENTION

Provided herein is a method of preparing a cathode slurry for a secondary battery, comprising the steps of:
1) dispersing a binder composition A and a cathode active material in an aqueous solvent to form a first mixture;
2) adding a binder composition B into the first mixture to form a second mixture; and
3) homogenizing the second mixture to obtain a cathode slurry.

The term “electrode” refers to a “cathode” or an “anode.”

The term “cathode component” refers to any substance that is present in an electrode layer of a cathode, including but not limited to cathode active materials, conductive agents, and binder materials.

The term “positive electrode” is used interchangeably with cathode. Likewise, the term “negative electrode” is used interchangeably with anode.

The term “binder material” refers to a chemical compound, a mixture of compounds, or a polymer that is used to hold an electrode active material and/or a conductive agent in place and adhere them onto a current collector to form an electrode. In some embodiments, the electrode does not comprise any conductive material or conductive agent.

The term “binder composition” refers to a material comprising a binder material that is used in the manufacturing of an electrode. In some embodiments, a binder composition comprises a binder material and a dispersion medium.

The term “conductive agent” refers to a material that has good electrical conductivity. Therefore, a conductive agent is often mixed with an electrode active material at the time of forming an electrode to improve electrical conductivity of the electrode. In some embodiments, the conductive agent is chemically active. In other embodiments, the conductive agent is chemically inactive.

With respect to a solvent, the term “aqueous” means that the solvent contains water as the major component and one or more minor components in addition to water, or consists solely of water.

The term “unsaturated” refers to a moiety having one or more units of unsaturation.

The term “alkyl” or “alkyl group” refers to a univalent group having the general formula CₙH₂ₙ₊₁ derived from removing a hydrogen atom from a saturated, unbranched or branched aliphatic hydrocarbon, where n is an integer.

The term “cycloalkyl” or “cycloalkyl group” refers to a saturated or unsaturated cyclic non-aromatic hydrocarbon radical having a single ring or multiple condensed rings. A cycloalkyl group can be unsubstituted or substituted by one or two suitable substituents. Furthermore, the cycloalkyl group can be monocyclic or polycyclic.

The term “alkenyl” refers to a univalent group derived from the removal of a hydrogen atom from any carbon atom of an unsaturated aliphatic hydrocarbon with at least one carbon-carbon double bond. Similarly, the term “alkynyl” refers to a univalent group derived from the removal of a hydrogen atom from any carbon atom of an unsaturated aliphatic hydrocarbon with at least one carbon-carbon triple bond. Furthermore, the term “enynyl” refers to a univalent group derived from the removal of a hydrogen atom from any carbon atom of an unsaturated aliphatic hydrocarbon with at least one carbon-carbon double bond and at least one carbon-carbon triple bond. The unsaturated aliphatic hydrocarbon of an alkenyl, alkynyl or enynyl may be branched or unbranched.

The term “alkoxy” refers to an alkyl group attached to the principal carbon chain through an oxygen atom. An alkoxy group may be substituted or unsubstituted.

The term “aryl” or “aryl group” refers to an organic radical derived from a monocyclic or polycyclic aromatic hydrocarbon by removing a hydrogen atom. An aryl group can be unsubstituted or substituted with one or more suitable substituents. Furthermore, the aryl group can be monocyclic or polycyclic.

The term “alkylamino” refers to a group derived from the removal of a hydrogen atom from a primary or secondary amine. Alkylamino embraces the terms “N-alkylamino” and “N,N-dialkylamino”, wherein the amino group is independently substituted with one or two alkyl groups, respectively. The alkylamino group is optionally substituted with one or more substituents.

The term “alkylthio” refers to a group containing a branched or unbranched alkyl group attached to a divalent sulfur atom. The alkylthio group is optionally substituted with one or more substituents.

The term “heteroatom” refers to one or more of oxygen (O), sulfur (S), nitrogen (N), phosphorus (P) or silicon (Si), including any oxidized form of nitrogen (N), sulfur (S) or phosphorus (P); the quaternized form of any basic nitrogen; or a substitutable nitrogen of a heterocyclic ring.

The term “aliphatic” refers to non-aromatic hydrocarbon or groups derived therefrom.

The term “aromatic” refers to groups comprising aromatic hydrocarbon rings, optionally including heteroatoms or substituents.

The term “substituted” is used to describe a compound or chemical moiety wherein at least one hydrogen atom of that compound or chemical moiety is replaced with a second chemical moiety. Examples of substituents include, but are not limited to, halogen; alkyl; heteroalkyl; alkenyl; alkynyl; enynyl; aryl, heteroaryl, hydroxyl; alkoxyl; amino; nitro; thiol; alkylthio; imine; cyano; amido; phosphonato; phosphinato; carboxyl; thiocarbonyl; sulfonyl; sulfonamide; acyl; formyl; acyloxy; alkoxycarbonyl; oxo; haloalkyl; carbocyclic cycloalkyl; carbocyclic or heterocyclic aryl; amino, monoalkylamino and dialkylamino; o-lower alkyl; o-aryl, aryl; aryl-lower alkyl; —CO₂CH₃; —CONH₂; —OCH₂CONH₂; —NH₂; —SO₂NH₂; —OCHF₂; —CF₃; —OCF₃; —NH(alkyl); —N(alkyl)₂; —NH(aryl); —N(alkyl)(aryl); —N(aryl)₂; —CHO; —CO(alkyl); —CO(aryl); —CO₂(alkyl); and —CO₂(aryl); and such moieties can also be optionally substituted by a fused-ring structure or bridge. These substituents can optionally be further substituted with one or more substituents. All chemical groups disclosed herein can be substituted, unless specified otherwise.

The term “halogen” or “halo” refers to F, Cl, Br or I.

The abbreviation “(meth)acryl-” includes both “acryl-” and “methacryl-”.

The term “polymer” refers to a compound prepared by polymerizing monomers, whether of the same type or of different types. The generic term “polymer” embraces the terms “homopolymer” as well as “copolymer”.

The term “homopolymer” refers to a polymer prepared by the polymerization of the same type of monomer.

The term “copolymer” refers to a polymer prepared by the polymerization of two or more different types of monomers.

The term “monomeric unit” refers to the constitutional unit contributed by a single monomer to the structure of a polymer.

The term “structural unit” refers to the total monomeric units derived from the same monomer type in a polymer.

The term “homogenizer” refers to an equipment that can be used to homogenize materials, i.e., to distribute materials uniformly throughout a fluid. Where homogenization is disclosed herein, any conventional homogenizer can be used for the homogenization process.

The term “solid content” refers to the amount of non-volatile material remaining after evaporation.

The term “applying” refers to an act of laying or spreading a substance on a surface.

The term “current collector” refers to any conductive substrate, which is in contact with an electrode layer and is capable of conducting an electrical current flowing in electrodes during discharging or charging a secondary battery. Some non-limiting examples of the current collector include a single metal layer or single substrate, and a single metal layer or substrate with an overlying conductive coating layer, such as a carbon black-based coating layer. The metal layer or substrate may be in the form of a foil or a porous body having a three-dimensional network structure, and may be a polymeric or metallic material or a metalized polymer.

The term “electrode layer” refers to a layer that is in contact with a current collector and which comprises an electrochemically active material. In some embodiments, the electrode layer is made by applying a slurry on to the current collector. In some embodiments, the electrode layer is located on the surface of the current collector. In other embodiments, the three-dimensional porous current collector is coated conformally with an electrode layer.

The term “room temperature” refers to indoor temperatures from about 18° C. to about 30° C., e.g., 18, 19, 20, 21, 22, 23, 24, 25, 26, 27, 28, 29, or 30° C. In some embodiments, room temperature refers to a temperature of about 20° C.+/−1° C. or +/−2° C. or +/−3° C. In other embodiments, room temperature refers to a temperature of about 22° C. or about 25° C.

The term “peeling strength” refers to the amount of force required to separate two materials that are adhered to each other, such as a current collector and an electrode layer. It is a measure of the adhesion strength between such two materials and is usually expressed in N/cm.

The term “adhesive strength” refers to the amount of force required to separate a substrate and a binder material adhered to the substrate. It is a measure of the adhesion performance of the binder material towards the substrate and is usually expressed in N/cm.

The term “C rate” refers to the charging or discharging rate of a cell or battery, expressed in terms of its total storage capacity in Ah or mAh. For example, a rate of 1 C means utilization of all of the stored energy in one hour; a 0.1 C means utilization of 10% of the energy in one hour or full energy in 10 hours; and a 5 C means utilization of full energy in 12 minutes.

The term “ampere-hour (Ah)” refers to a unit used in specifying the storage capacity of a battery. For example, a battery with 1 Ah capacity can supply a current of one ampere for one hour or 0.5 A for two hours, etc. Therefore, 1 ampere-hour (Ah) is the equivalent of 3,600 coulombs of electrical charge. Similarly, the term “milliampere-hour (mAh)” also refers to a unit of the storage capacity of a battery and is 1/1,000 of an ampere-hour.

The term “capacity” is a characteristic of an electrochemical cell that refers to the total amount of electrical charge an electrochemical cell, such as a battery, is able to hold. Capacity is typically expressed in units of ampere-hours. The term “specific capacity” refers to the capacity output of an electrochemical cell, such as a battery, per unit weight, usually expressed in Ah/kg or mAh/g.

In the following description, all numbers disclosed herein are approximate values, regardless of whether the word “about” or “approximate” is used in connection therewith. They may vary by 1 percent, 2 percent, 5 percent, or, sometimes, 10 to 20 percent. Whenever a numerical range with a lower limit, R^{L}, and an upper limit, R^{U}, is disclosed, any number falling within the range is specifically disclosed. In particular, the following numbers within the range are specifically disclosed: R=R^{L}+k*(R^{U}—R_{L}), wherein k is a variable ranging from 0 percent to 100 percent. Moreover, any numerical range defined by two R numbers as defined in the above is also specifically disclosed.

In the present description, all references to the singular include references to the plural and vice versa.

Currently, cathodes of lithium-ion batteries are often prepared by dispersing a cathode active material, a binder material, and a conductive agent in solvent to form a cathode slurry, then coating the cathode slurry onto a current collector and drying it. PVDF is commonly used as the binder material as it can bring about good battery cycling stability, but it can only dissolve in specific organic solvents such as NMP. NMP, however, is hazardous and mitigation of these hazards is costly. To avoid these disadvantages, methods of cathode manufacturing using slurries comprising aqueous solvents have been devised, yet the electrochemical performance of batteries comprising these cathodes leave much to be desired.

The present invention provides for a method of preparing a cathode slurry for a secondary battery. The sole FIGURE is a flow chart illustrating the steps of method 100, an embodiment of the present invention. In some embodiments, a first mixture is formed by dispersing a binder composition A and a cathode active material in an aqueous solvent in step 101.

In some embodiments, the binder composition A comprises a copolymer P₁ as the binder material. In certain embodiments, the binder composition A further comprises a dispersion medium. There are no particular limitations to the dispersion medium in the binder composition A, but the dispersion medium should be miscible with the aqueous solvent of the cathode slurry, such that the cathode slurry can be homogeneous. Any substance suitable for use as the aqueous solvent can also be used as the dispersion medium in the binder composition A. In some embodiments, the aqueous solvent of the cathode slurry and the dispersion medium in the binder composition A are the same, are different, or are partially different.

In some embodiments, the copolymer P₁ comprises the structural units (a₁), (b₁), and (c₁). In some embodiments, the structural unit (a₁) is derived from an acid group-containing monomer. In certain embodiments, the acid group is selected from the group consisting of carboxylic acid, sulfonic acid, sulfuric acid, phosphonic acid, phosphoric acid, nitric acid, and combinations thereof. The acids listed above also include their salts and derivatives. In some embodiments, the salt of the acid comprises an alkali metal cation. Examples of an alkali metal forming the alkali metal cation include lithium, sodium, and potassium. In some embodiments, the salt of the acid comprises an ammonium cation.

In some embodiments, the carboxylic acid is acrylic acid, methacrylic acid, crotonic acid, 2-butyl crotonic acid, cinnamic acid, maleic acid, maleic anhydride, fumaric acid, itaconic acid, itaconic anhydride, tetraconic acid, or a combination thereof. In certain embodiments, the carboxylic acid is 2-ethylacrylic acid, isocrotonic acid, cis-2-pentenoic acid, trans-2-pentenoic acid, angelic acid, tiglic acid, 3,3-dimethyl acrylic acid, 3-propyl acrylic acid, trans-2-methyl-3-ethyl acrylic acid, cis-2-methyl-3-ethyl acrylic acid, 3-isopropyl acrylic acid, trans-3-methyl-3-ethyl acrylic acid, cis-3-methyl-3-ethyl acrylic acid, 2-isopropyl acrylic acid, trimethyl acrylic acid, 2-methyl-3,3-diethyl acrylic acid, 3-butyl acrylic acid, 2-butyl acrylic acid, 2-pentyl acrylic acid, 2-methyl-2-hexenoic acid, trans-3-methyl-2-hexenoic acid, 3-methyl-3-propyl acrylic acid, 2-ethyl-3-propyl acrylic acid, 2,3-diethyl acrylic acid, 3,3-diethyl acrylic acid, 3-methyl-3-hexyl acrylic acid, 3-methyl-3-tert-butyl acrylic acid, 2-methyl-3-pentyl acrylic acid, 3-methyl-3-pentyl acrylic acid, 4-methyl-2-hexenoic acid, 4-ethyl-2-hexenoic acid, 3-methyl-2-ethyl-2-hexenoic acid, 3-tert-butyl acrylic acid, 2,3-dimethyl-3-ethyl acrylic acid, 3,3-dimethyl-2-ethyl acrylic acid, 3-methyl-3-isopropyl acrylic acid, 2-methyl-3-isopropyl acrylic acid, trans-2-octenoic acid, cis-2-octenoic acid, trans-2-decenoic acid, α-acetoxyacrylic acid, β-trans-aryloxyacrylic acid, α-chloro-β-E-methoxyacrylic acid, or a combination thereof.

In some embodiments, the sulfonic acid is vinylsulfonic acid, methylvinylsulfonic acid, allylvinylsulfonic acid, allylsulfonic acid, methallylsulfonic acid, styrenesulfonic acid, 2-sulfoethyl methacrylic acid, 2-methylprop-2-ene-1-sulfonic acid, 2-acrylamido-2-methyl-1-propane sulfonic acid, 3-allyloxy-2-hydroxy-1-propane sulfonic acid, or a combination thereof.

In some embodiments, the sulfuric acid is allyl hydrogen sulfate, vinyl hydrogensulfate, 4-allyl phenol sulphate, or a combination thereof.

In some embodiments, the phosphonic acid is phosphonoxyethyl acrylate, phosphonoxyethyl methacrylate, vinyl phosphonic acid, allyl phosphonic acid, 3-butenyl phosphonic acid, styrene phosphonic acid, vinyl benzyl phosphonic acid, (2-chloro-2-phenyl-vinyl)-phosphonic acid, acrylamide alkyl phosphonic acid, methacrylamide alkyl phosphonic acid, acrylamide alkyl diphosphonic acid, acryloylphosphonic acid, 2-methacryloyloxyethyl phosphonic acid, bis(2-methacryloyloxyethyl) phosphonic acid, 2-methacryloyloxyethyl phosphonic acid, ethyl-methacryloyloxyethyl phosphonic acid, or a combination thereof.

In some embodiments, the phosphoric acid is mono (2-acryloyloxyethyl) phosphate, mono (2-methacryloyloxyethyl) phosphate, diphenyl (2-acryloyloxyethyl) phosphate, diphenyl (2-methacryloyloxyethyl) phosphate, phenyl (2-acryloyloxyethyl) phosphate, phosphoxyethyl methacrylate, 3-chloro-2-phosphoryloxy propyl methacrylate, phosphoryloxy poly(ethylene glycol) monomethacrylate, phosphoryloxy poly(propylene glycol) methacrylate, (meth)acryloyloxyethyl phosphate, (meth)acryloyloxypropyl phosphate, (meth)acryloyloxy-2-hydroxypropyl phosphate, (meth)acryloyloxy-3-hydroxypropyl phosphate, (meth)acryloyloxy-3-chloro-2 hydroxypropyl phosphate, allyl hydrogen phosphate, vinyl hydrogen phosphate, allyl hydrogen pyrophosphate, vinyl hydrogen pyrophosphate, allyl hydrogen tripolyphosphate, vinyl hydrogen tripolyphosphate, allyl hydrogen tetrapolyphosphate, vinyl hydrogen tetrapolyphosphate, allyl hydrogen trimetaphosphate, vinyl hydrogen trimetaphosphate, isopentenyl phosphate, isopentenyl pyrophosphate, or a combination thereof.

In some embodiments, the nitric acid is allyl hydrogen nitrate, ethenyl hydrogen nitrate, or a combination thereof.

In some embodiments, the proportion of the structural unit (a₁) within the copolymer P₁ is from about 45% to about 80%, from about 46% to about 80%, from about 47% to about 80%, from about 48% to about 80%, from about 49% to about 80%, from about 50% to about 80%, from about 52% to about 80%, from about 55% to about 80%, from about 58% to about 60%, from about 60% to about 80%, from about 62% to about 80%, from about 65% to about 80%, from about 68% to about 80%, from about 70% to about 80%, from about 45% to about 70%, from about 50% to about 70%, from about 55% to about 70%, from about 60% to about 70%, from about 45% to about 60%, from about 50% to about 60%, or from about 55% to about 60% by mole, based on the total number of moles of monomeric units in the copolymer.

In some embodiments, the proportion of the structural unit (a₁) within the copolymer P₁ is less than 80%, less than 79%, less than 78%, less than 77%, less than 76%, less than 75%, less than 70%, less than 65%, less than 60%, less than 55%, less than 50%, less than 49%, less than 48%, less than 47%, or less than 46% by mole, based on the total number of moles of monomeric units in the copolymer. In some embodiments, the proportion of the structural unit (a₁) within the copolymer P₁ is more than 45%, more than 46%, more than 47%, more than 48%, more than 49%, more than 50%, more than 55%, more than 60%, more than 65%, more than 70%, more than 75%, more than 76%, more than 77%, more than 78%, or more than 79% by mole, based on the total number of moles of monomeric units in the copolymer.

In some embodiments, the structural unit (b₁) is derived from a monomer selected from the group consisting of an amide group-containing monomer, a hydroxyl group-containing monomer, and combinations thereof.

In some embodiments, the amide group-containing monomer is acrylamide, methacrylamide, N-methyl methacrylamide, N-ethyl methacrylamide, N-n-propyl methacrylamide, N-isopropyl methacrylamide, isopropyl acrylamide, N-n-butyl methacrylamide, N-isobutyl methacrylamide, N,N-dimethyl acrylamide, N,N-dimethyl methacrylamide, N,N-diethyl acrylamide, N,N-diethyl methacrylamide, N-methylol methacrylamide, N-(methoxymethyl)methacrylamide, N-(ethoxymethyl)methacrylamide, N-(propoxymethyl)methacrylamide, N-(butoxymethyl)methacrylamide, N,N-dimethylaminopropyl methacrylamide, N,N-dimethylaminoethyl methacrylamide, N,N-dimethylol methacrylamide, diacetone methacrylamide, diacetone acrylamide, methacryloyl morpholine, N-hydroxyl methacrylamide, N-methoxymethyl acrylamide, N-methoxymethyl methacrylamide, N,N′-methylene-bis-acrylamide (MBA), N-hydroxymethyl acrylamide, or a combination thereof.

In some embodiments, the hydroxyl group-containing monomer is an acrylate or methacrylate containing a C₁-C₂₀ alkyl or C₅-C₂₀ cycloalkyl with a hydroxyl group. In some embodiments, the hydroxyl group-containing monomer is 2-hydroxyethylacrylate, 2-hydroxyethyl methacrylate, 2-hydroxypropyl acrylate, 2-hydroxypropyl methacrylate, 2-hydroxybutyl methacrylate, 3-hydroxypropylacrylate, 3-hydroxypropylmethacrylate, 4-hydroxybutyl methacrylate, 5-hydroxypentylacrylate, 6-hydroxyhexyl methacrylate, 1,4-cyclohexanedimethanol monoacrylate, 1,4-cyclohexanedimethanol monomethacrylate, 3-chloro-2-hydroxypropyl methacrylate, diethylene glycol monoacrylate, diethylene glycol monomethacrylate, allyl alcohol, or a combination thereof.

In some embodiments, the proportion of structural unit (b₁) within the copolymer P₁ is from about 10% to about 35%, from about 13% to about 35%, from about 15% to about 35%, from about 18% to about 35%, from about 20% to about 35%, from about 23% to about 35%, from about 25% to about 35%, from about 28% to about 35%, from about 30% to about 35%, from about 10% to about 32%, from about 13% to about 32%, from about 15% to about 32%, from about 18% to about 32%, from about 20% to about 32%, from about 23% to about 32%, from about 25% to about 32%, from about 28% to about 32%, from about 10% to about 30%, from about 13% to about 30%, from about 15% to about 30%, from about 18% to about 30%, from about 20% to about 30%, from about 23% to about 30%, from about 25% to about 30%, from about 10% to about 28%, from about 13% to about 28%, from about 15% to about 28%, from about 18% to about 28%, from about 20% to about 28%, from about 10% to about 25%, from about 13% to about 25%, from about 15% to about 25%, from about 18% to about 25%, from about 20% to about 25%, from about 10% to about 22%, from about 13% to about 22%, from about 15% to about 22%, from about 10% to about 20%, from about 13% to about 20%, or from about 15% to about 20% by mole, based on the total number of moles of monomeric units in the copolymer.

In some embodiments, the proportion of the structural unit (b₁) within the copolymer P₁ is less than 35%, less than 32%, less than 30%, less than 28%, less than 25%, less than 23%, less than 20%, less than 18%, less than 15%, or less than 13% by mole, based on the total number of moles of monomeric units in the copolymer. In some embodiments, the proportion of the structural unit (b₁) within the copolymer P₁ is more than 10%, more than 13%, more than 15%, more than 18%, more than 20%, more than 23%, more than 25%, more than 28%, or more than 30% by mole, based on the total number of moles of monomeric units in the copolymer.

In some embodiments, the structural unit (c₁) is derived from a monomer selected from the group consisting of a nitrile group-containing monomer, an ester group-containing monomer, an epoxy group-containing monomer, and combinations thereof.

In some embodiments, the nitrile group-containing monomer is or comprises an α,β-ethylenically unsaturated nitrile monomer. In some embodiments, the nitrile group-containing monomer is acrylonitrile, α-halogenoacrylonitrile, α-alkylacrylonitrile, or a combination thereof. In some embodiments, the nitrile group-containing monomer is α-chloroacrylonitrile, α-bromoacrylonitrile, α-fluoroacrylonitrile, methacrylonitrile, α-ethylacrylonitrile, α-isopropylacrylonitrile, α-n-hexylacrylonitrile, α-methoxyacrylonitrile, 3-methoxyacrylonitrile, 3-ethoxyacrylonitrile, α-acetoxyacrylonitrile, α-phenylacrylonitrile, α-tolylacrylonitrile, α-(methoxyphenyl)acrylonitrile, α-(chlorophenyl)acrylonitrile, α-(cyanophenyl)acrylonitrile, vinylidene cyanide, or a combination thereof.

In some embodiments, the ester group-containing monomer is C₁-C₂₀ alkyl acrylate, C₁-C₂₀ alkyl methacrylate, cycloalkyl acrylate, or a combination thereof. In some embodiments, the ester group-containing monomer is methyl acrylate, ethyl acrylate, n-propyl acrylate, isopropyl acrylate, n-butyl acrylate, sec-butyl acrylate, tert-butyl acrylate, pentyl acrylate, hexyl acrylate, heptyl acrylate, octyl acrylate, 3,3,5-trimethylhexyl acrylate, 2-ethylhexyl acrylate, nonyl acrylate, decyl acrylate, lauryl acrylate, n-tetradecyl acrylate, octadecyl acrylate, cyclohexyl acrylate, phenyl acrylate, methoxymethyl acrylate, methoxyethyl acrylate, ethoxymethyl acrylate, ethoxyethyl acrylate, perfluorooctyl acrylate, stearyl acrylate, or a combination thereof.

In some embodiments, the epoxy group-containing monomer is vinyl glycidyl ether, allyl glycidyl ether, allyl 2,3-epoxypropyl ether, butenyl glycidyl ether, butadiene monoepoxide, chloroprene monoepoxide, 3,4-epoxy-1-butene, 4,5-epoxy-2-pentene, 3,4-epoxy-1-vinylcyclohexane, 1,2-epoxy-4-vinylcyclohexane, 3,4-epoxy cyclohexylethylene, epoxy-4-vinylcyclohexene, 1,2-epoxy-5,9-cyclododecadiene, or a combination thereof.

In some embodiments, the proportion of the structural unit (c₁) within the copolymer P₁ is from about 10% to about 40%, from about 12% to about 40%, from about 15% to about 40%, from about 18% to about 40%, from about 20% to about 40%, from about 22% to about 40%, from about 25% to about 40%, from about 28% to about 40%, from about 30% to about 40%, from about 10% to about 38%, from about 12% to about 38%, from about 14% to about 38%, from about 16% to about 38%, from about 18% to about 38%, from about 20% to about 38%, from about 22% to about 38%, from about 25% to about 38%, from about 28% to about 38%, from about 10% to about 35%, from about 12% to about 35%, from about 15% to about 35%, from about 18% to about 35%, from about 20% to about 35%, from about 22% to about 35%, from about 25% to about 35%, from about 10% to about 32%, from about 12% to about 32%, from about 15% to about 32%, from about 18% to about 32%, from about 20% to about 32%, from about 22% to about 32%, from about 10% to about 30%, from about 12% to about 30%, from about 15% to about 30%, from about 18% to about 30%, from about 20% to about 30%, from about 10% to about 28%, from about 12% to about 28%, from about 15% to about 28%, from about 18% to about 28%, from about 10% to about 25%, from about 12% to about 25%, or from about 15% to about 25% by mole, based on the total number of moles of monomeric units in the copolymer.

In some embodiments, the proportion of the structural unit (c₁) within the copolymer P₁ is less than 40%, less than 38%, less than 35%, less than 32%, less than 30%, less than 28%, less than 25%, less than 22%, less than 20%, less than 18%, or less than 15% by mole, based on the total number of moles of monomeric units in the copolymer. In some embodiments, the proportion of the structural unit (c₁) within the copolymer P₁ is more than 10%, more than 12%, more than 15%, more than 18%, more than 20%, more than 22%, more than 25%, more than 28%, more than 30%, more than 32%, or more than 35% by mole, based on the total number of moles of monomeric units in the copolymer.

The weight-average molecular weight (M_{w}) of a copolymeric binder material is one of the factors that affect the adhesive performance of the copolymer, which affects the ability of the electrode layer to remain adhered to the current collector and hence the battery cycling stability. The M_{w} of the copolymer also affects the dispersibility of the copolymer in the aqueous solvent. When the weight-average molecular weight of copolymer P₁ is within the ranges set forth below, the adhesive performance and dispersibility of copolymer P₁ is improved.

In some embodiments, the M_{w} of copolymer P₁ is from about 10,000 g/mol to about 600,000 g/mol, from about 50,000 g/mol to about 600,000 g/mol, from about 100,000 g/mol to about 600,000 g/mol, from about 200,000 g/mol to about 600,000 g/mol, from about 400,000 g/mol to about 600,000 g/mol, from about 10,000 g/mol to about 400,000 g/mol, from about 50,000 g/mol to about 400,000 g/mol, from about 100,000 g/mol to about 400,000 g/mol, from about 200,000 g/mol to about 400,000 g/mol, from about 10,000 g/mol to about 300,000 g/mol, from about 30,000 g/mol to about 300,000 g/mol, from about 50,000 g/mol to about 300,000 g/mol, from about 75,000 g/mol to about 300,000 g/mol, from about 100,000 g/mol to about 300,000 g/mol, from about 150,000 g/mol to about 300,000 g/mol, from about 200,000 g/mol to about 300,000 g/mol, from about 10,000 g/mol to about 250,000 g/mol, from about 30,000 g/mol to about 250,000 g/mol, from about 50,000 g/mol to about 250,000 g/mol, from about 100,000 g/mol to about 250,000 g/mol, from about 150,000 g/mol to about 250,000 g/mol, from about 10,000 g/mol to about 200,000 g/mol, from about 30,000 g/mol to about 200,000 g/mol, from about 50,000 g/mol to about 200,000 g/mol, from about 100,000 g/mol to about 200,000 g/mol, from about 10,000 g/mol to about 150,000 g/mol, from about 30,000 g/mol to about 150,000 g/mol, from about 50,000 g/mol to about 150,000 g/mol, or from about 75,000 g/mol to about 150,000 g/mol.

In some embodiments, the M_{w} of copolymer P₁ is less than 600,000 g/mol, less than 500,000 g/mol, less than 400,000 g/mol, less than 300,000 g/mol, less than 250,000 g/mol, less than 200,000 g/mol, less than 175,000 g/mol, less than 150,000 g/mol, less than 125,000 g/mol, less than 100,000 g/mol, less than 90,000 g/mol, less than 80,000 g/mol, less than 70,000 g/mol, less than 60,000 g/mol, or less than 50,000 g/mol. In some embodiments, the M_{w} of copolymer P₁ is more than 10,000 g/mol, more than 15,000 g/mol, more than 20,000 g/mol, more than 25,000 g/mol, more than 30,000 g/mol, more than 35,000 g/mol, more than 40,000 g/mol, more than 50,000 g/mol, more than 60,000 g/mol, more than 70,000 g/mol, more than 80,000 g/mol, more than 100,000 g/mol, more than 150,000 g/mol, more than 175,000 g/mol, more than 200,000 g/mol, more than 300,000 g/mol, more than 400,000 g/mol or more than 500,000 g/mol.

In some embodiments, the solid content of the binder composition A is from about 5% to about 25%, from about 6% to about 25%, from about 7% to about 25%, from about 8% to about 25%, from about 9% to about 25%, from about 10% to about 25%, from about 11% to about 25%, from about 12% to about 25%, from about 13% to about 25%, from about 14% to about 25%, from about 15% to about 25%, from about 5% to about 22%, from about 6% to about 22%, from about 7% to about 22%, from about 8% to about 22%, from about 9% to about 22%, from about 10% to about 22%, from about 11% to about 22%, from about 12% to about 22%, from about 13% to about 22%, from about 14% to about 22%, from about 15% to about 22%, from about 5% to about 20%, from about 6% to about 20%, from about 7% to about 20%, from about 8% to about 20%, from about 9% to about 20%, from about 10% to about 20%, from about 5% to about 17%, from about 6% to about 17%, from about 7% to about 17%, from about 8% to about 17%, from about 9% to about 17%, from about 10% to about 17%, from about 5% to about 15%, from about 6% to about 15%, from about 7% to about 15%, from about 8% to about 15%, from about 9% to about 15%, or from about 10% to about 15% by weight, based on the total weight of the binder composition A.

In some embodiments, the solid content of the binder composition A is less than 25%, less than 23%, less than 20%, less than 19%, less than 18%, less than 17%, less than 16%, less than 15%, less than 14%, less than 13%, or less than 10% by weight, based on the total weight of the binder composition A. In some embodiments, the solid content of the binder composition A is more than 5%, more than 6%, more than 7%, more than 8%, more than 9%, more than 10%, more than 11%, more than 12%, more than 13%, more than 14%, more than 15%, more than 16%, more than 17%, more than 18%, more than 19%, or more than 20% by weight, based on the total weight of the binder composition A.

One of the advantages of the present invention is that an aqueous solvent can be used in the cathode slurry, minimizing the environmental impact and improving the safety of the cathode manufacturing process. In certain embodiments, the aqueous solvent is water. In some embodiments, the aqueous solvent is selected from the group consisting of tap water, bottled water, purified water, pure water, distilled water, de-ionized water (DI water), D₂O, and combinations thereof.

In some embodiments, the aqueous solvent comprises water and a minor component in addition to water. In some embodiments, the volume ratio of water to the minor component is from about 51:49 to about 99:1. Any water-miscible or volatile solvents can be used as the minor component. Some non-limiting examples of the minor component include alcohols, lower aliphatic ketones, lower alkyl acetates, and combinations thereof. The addition of a minor component can improve the processibility of the cathode slurry.

Some non-limiting examples of the alcohol include C₁-C₄ alcohols, such as methanol, ethanol, isopropanol, n-propanol, tert-butanol, n-butanol, 1,2-butanediol, 1,3-butanediol, 1,4-butanediol, 2,3-butanediol, ethylene glycol, propylene glycol, glycerol, and combinations thereof. Some non-limiting examples of the lower aliphatic ketones include acetone, dimethyl ketone, methyl ethyl ketone (MEK), and combinations thereof. Some non-limiting examples of the lower alkyl acetates include ethyl acetate (EA), isopropyl acetate, propyl acetate, butyl acetate (BA), and combinations thereof. Some other non-limiting examples of the water-miscible solvents or volatile solvents include 1,4-dioxane, diethyl ether, methyl tert-butyl ether, cyclopentyl methyl ether, tetrahydrofuran (THF), 2-methyl tetrahydrofuran, acetonitrile, dimethyl sulfoxide (DMSO), sulfolane, nitromethane, propylene carbonate, ethylene carbonate, dimethyl carbonate, pyridine, acetaldehyde, formic acid, acetic acid, propanoic acid, butyric acid, 7-valerolactone (GVL), furfuryl alcohol, methyl lactate, ethyl lactate, diethanolamine, dimethylacetamide (DMAc), dimethylformamide (DMF), N-methylpyrrolidone (NMP), dihydrolevoglucosenone (Cyrene™), N,N′-dimethylpropyleneurea (DMPU), and dimethyl isosorbide (DMI). In some embodiments, no minor component is present in the aqueous solvent.

The cathode active material should be selected based on the type of battery that is being produced. In some embodiments, the type of battery may be a primary battery or a secondary battery. Some non-limiting examples of battery types include alkaline batteries, aluminum-air batteries, lithium batteries, lithium air batteries, magnesium batteries, silver-oxide batteries, zinc-air batteries, aluminum-ion batteries, lead-acid batteries, lithium-ion batteries, magnesium-ion batteries, potassium-ion batteries, sodium-ion batteries, sodium-air batteries, silicon-air batteries, zinc-ion batteries, and sodium-sulfur batteries.

In some embodiments, the cathode active material is for a lithium-ion battery. In some embodiments, the cathode active material for a lithium-ion battery is selected from the group consisting of LiCoO₂, LiNiO₂, LiNi₁₋ₓMₓO₂, LiNiₓMn_{y}O₂, LiCoₓNi_{y}O₂, Li_{1+z}NiₓMn_{y}Co_{1-x-y}O₂, LiNiₓCo_{y}Al_{z}O₂, LiV₂O₅, LiTiS₂, LiMoS₂, LiMnO₂, LiCrO₂, LiMn₂O₄, Li₂MnO₃, LiFeO₂, LiFePO₄, and combinations thereof, wherein each x is independently from 0.1 to 0.9; each y is independently from 0 to 0.9; each z is independently from 0 to 0.4; and M is selected from the group consisting of Co, Mn, Al, Fe, Ti, Ga, Mg, and combinations thereof.

In certain embodiments, the cathode active material for a lithium-ion battery is selected from the group consisting of LiNiₓMn_{y}O₂, Li_{1+z}NiₓMn_{y}Co_{1-x-y}O₂ (NMC), LiNiₓCo_{y}Al_{z}O₂ (NCA), LiCoₓNi_{y}O₂, and combinations thereof, wherein each x is independently from 0.4 to 0.6; each y is independently from 0.2 to 0.4; and each z is independently from 0 to 0.1. In other embodiments, the cathode active material for a lithium-ion battery is not LiCoO₂, LiNiO₂, LiV₂O₅, LiTiS₂, LiMoS₂, LiMnO₂, LiCrO₂, LiMn₂O₄, LiFeO₂ or LiFePO₄. In further embodiments, the cathode active material for a lithium-ion battery is not LiNiₓMn_{y}O₂, Li_{1+z}NiₓMn_{y}Co_{1-x-y}O₂, LiNiₓCo_{y}Al_{z}O₂ or LiCoₓNi_{y}O₂, wherein each x is independently from 0.1 to 0.9; each y is independently from 0 to 0.45; and each z is independently from 0 to 0.2. In certain embodiments, the cathode active material for a lithium-ion battery is Li₁₊ₓNiₐMn_{b}Co_{c}Al_{(1-a-b-c)}O₂; wherein −0.2≤x≤0.2, 0≤a≤1, 0≤b≤1, 0≤c≤1, and a+b+c≤1. In some embodiments, the cathode active material for a lithium-ion battery has the general formula Li₁₊ₓNiₐMn_{b}Co_{c}Al_{(1-a-b-c)}O₂, wherein 0.33≤a≤0.92, 0≤b≤0.5 and 0≤c≤0.5. In some embodiments, the cathode active material for a lithium-ion battery has the general formula LiMPO₄, wherein M is selected from the group consisting of Fe, Co, Ni, Mn, Al, Mg, Zn, Ti, La, Ce, Sn, Zr, Ru, Si, Ge, and combinations thereof.

In some embodiments, the cathode active material for a lithium-ion battery is selected from the group consisting of LiFePO₄, LiCoPO₄, LiNiPO₄, LiMnPO₄, LiMnFePO₄, LiMnₓFe₍₁₋ₓ₎PO₄, and combinations thereof; wherein 0<x<1. In some embodiments, the cathode active material for a lithium-ion battery is LiNiₓMn_{y}O₄; wherein 0.1≤x≤0.9 and 0≤y≤². In certain embodiments, the cathode active material for a lithium-ion battery is xLi₂MnO₃·(1−x)LiMO₂, wherein M is selected from the group consisting of Ni, Co, Mn, and combinations thereof; and wherein 0<x<1. In some embodiments, the cathode active material for a lithium-ion battery is Li₃V₂(PO₄)₃ or LiVPO₄F. In certain embodiments, the cathode active material for a lithium-ion battery has the general formula Li₂MSiO₄, wherein M is selected from the group consisting of Fe, Co, Mn, Ni, and combinations thereof.

In certain embodiments, the cathode active material for a lithium-ion battery is doped with a dopant selected from the group consisting of Co, Cr, V, Mo, Nb, Pd, F, Na, Fe, Ni, Mn, Al, Mg, Zn, Ti, La, Ce, Sn, Zr, Ru, Si, Ge, and combinations thereof. In some embodiments, the cathode active material for a lithium-ion battery is not doped with Co, Cr, V, Mo, Nb, Pd, F, Na, Fe, Ni, Mn, Mg, Zn, Ti, La, Ce, Ru, Si, or Ge. In certain embodiments, the cathode active material for a lithium-ion battery is not doped with Al, Sn or Zr.

In some embodiments, the cathode active material for a lithium-ion battery is LiNi_{0.33}Mn_{0.33}Co_{0.33}O₂(NMC333), LiNi_{0.4}Mn_{0.4}Co_{0.2}O₂, LiNi_{0.5}Mn_{0.3}Co_{0.2}O₂(NMC532), LiNi_{0.6}Mn_{0.2}Co_{0.2}O₂(NMC622), LiNi_{0.7}Mn_{0.15}Co_{0.15}O₂, LiNi_{0.7}Mn_{0.1}Co_{0.2}O₂, LiNi_{0.8}Mn_{0.1}Co_{0.1}O₂ (NMC811), LiNi_{0.92}Mn_{0.04}Co_{0.04}O₂, LiNi_{0.85}Mn_{0.075}Co_{0.075}O₂, LiNi_{0.8}Co_{0.15}Al_{0.05}O₂, LiNi_{0.88}Co_{0.1}Al_{0.02}O₂, LiNiO₂ (LNO), or a combination thereof.

In other embodiments, the cathode active material for a lithium-ion battery is not LiCoO₂, LiNiO₂, LiMnO₂, LiMn₂O₄ or Li₂MnO₃. In further embodiments, the cathode active material for a lithium-ion battery is not LiNi_{0.33}Mn_{0.33}Co_{0.33}O₂, LiNi_{0.4}Mn_{0.4}Co_{0.2}O₂, LiNi_{0.5}Mn_{0.3}Co_{0.2}O₂, LiNi_{0.6}Mn_{0.2}Co_{0.2}O₂, LiNi_{0.7}Mn_{0.15}Co_{0.15}O₂, LiNi_{0.7}Mn_{0.1}Co_{0.2}O₂, LiNi_{0.8}Mn_{0.1}Co_{0.1}O₂, LiNi_{0.92}Mn_{0.04}Co_{0.04}O₂, LiNi_{0.85}Mn_{0.075}Co_{0.075}O₂, LiNi_{0.8}Co_{0.15}Al_{0.05}O₂, or LiNi_{0.88}Co_{0.1}Al_{0.02}O₂.

In certain embodiments, the cathode active material for a lithium-ion battery comprises or is a core-shell composite having a core and shell structure, wherein the core comprises a lithium transition metal oxide selected from the group consisting of Li₁₊ₓNiₐMn_{b}Co_{c}Al_{(1-a-b-c)}O₂, LiCoO₂, LiNiO₂, LiMnO₂, LiMn₂O₄, Li₂MnO₃, LiCrO₂, Li₄Ti₅O₁₂, LiV₂O₅, LiTiS₂, LiMoS₂, LiCoₐNi_{b}O₂, LiMnₐNi_{b}O₂, and combinations thereof; wherein −0.2≤x≤0.2, 0≤a<1, 0≤b<1, 0≤c<1, and a+b+c≤1. In some embodiments, the shell also comprises a lithium transition metal oxide. In certain embodiments, the lithium transition metal oxide of the shell is selected from the above-mentioned group of lithium transitional metal oxides used for the core. In other embodiments, the shell comprises a transition metal oxide. In certain embodiments, the transition metal oxide of the shell is selected from the group consisting of Fe₂O₃, MnO₂, Al₂O₃, MgO, ZnO, TiO₂, La₂O₃, CeO₂, SnO₂, ZrO₂, RuO₂, and combinations thereof. In certain embodiments, the shell comprises a lithium transition metal oxide and a transition metal oxide.

In certain embodiments, the core and the shell for a lithium-ion battery each independently comprise two or more lithium transition metal oxides. In some embodiments, one of the core or shell comprises only one lithium transition metal oxide, while the other comprises two or more lithium transition metal oxides. The lithium transition metal oxide or oxides in the core and the shell may be the same, or they may be different or partially different. In some embodiments, the two or more lithium transition metal oxides are uniformly distributed over the core. In certain embodiments, the two or more lithium transition metal oxides are not uniformly distributed over the core.

In some embodiments, each of the metal oxides in the core and the shell is independently doped with a dopant selected from the group consisting of Co, Cr, V, Mo, Nb, Pd, F, Na, Fe, Ni, Mn, Al, Mg, Zn, Ti, La, Ce, Sn, Zr, Ru, Si, Ge, and combinations thereof. In some embodiments, the cathode active material is not a core-shell composite.

In some embodiments, the cathode active material is for a sodium-ion battery. In some embodiments, the cathode active material for a sodium-ion battery is a Prussian blue-type sodium compound that satisfies the formula NaₓM_{y}A_{z}, wherein M is one or more metals and A is one or more anions that comprise one or more of O, P, N, C, H or a halogen. In certain embodiments, the cathode active material for a sodium-ion battery is the sodium analogue of the cathode active materials for lithium-ion batteries as discussed above, with lithium replaced by sodium. In some embodiments, the cathode active material for a sodium-ion battery is selected from the group consisting of NaCoO₂, NaFeO₂, NaNiO₂, NaCrO₂, NaVO₂, NaTiO₂, NaFePO₄, Na₃V₂(PO₄)₃, Na₃V₂(PO₄)₂F₃, NMC-type mixed oxides, and combinations thereof. In some embodiments, the cathode active material for a sodium-ion battery is an organic material, such as disodium naphthalenediimide, doped quinone, pteridine derivatives, polyimides, polyamic acid, or a combination thereof.

In some embodiments, the cathode active material for a sodium-ion battery is comprises or is a core-shell composite having a core and shell structure. In some embodiments, the cathode active material for a sodium-ion battery is doped with a dopant. The same dopants listed above for the cathode active material for a lithium-ion battery can be used to dope the cathode active material for a sodium-ion battery.

In some embodiments, the average diameter of the cathode active material particles is from about 0.1 μm to about 100 μm, from about 0.1 μm to about 50 μm, from about 0.5 μm to about 50 μm, from about 0.5 μm to about 30 μm, from about 0.5 μm to about 20 μm, from about 1 μm to about 20 μm, from about 2.5 μm to about 50 μm, from about 2.5 μm to about 20 μm, from about 5 μm to about 50 μm, from about 5 μm to about 20 μm, from about 7.5 μm to about 20 μm, from about 10 μm to about 50 μm, from about 10 μm to about 20 μm, from about m to about 50 μm, from about 15 μm to about 20 μm, from about 20 μm to about 50 μm or from about 50 μm to about 100 μm.

In some embodiments, the average diameter of the cathode active material particles is less than 100 μm, less than 80 μm, less than 60 μm, less than 50 μm, less than 40 μm, less than 30 μm, less than 20 μm, less than 15 μm, less than 10 μm, less than 7.5 μm, less than 5 m, less than 2.5 μm, less than 1 μm, less than 0.75 μm or less than 0.5 μm. In some embodiments, the average diameter of the cathode active material particles is more than 0.1 μm, more than 0.25 μm, more than 0.5 μm, more than 0.75 μm, more than 1 μm, more than 2.5 μm, more than 5 μm, more than 7.5 μm, more than 10 μm, more than 15 μm, more than 20 μm, more than 30 μm, more than 40 μm or more than 50 μm.

In some embodiments, a conductive agent is also dispersed in the aqueous solvent in Step 101, in addition to the binder composition A and the cathode active material. When the conductive agent is added to the cathode slurry, the electrically conductive properties of the cathode produced therefrom would be enhanced. Therefore, it may be advantageous for Step 101 to further include the addition of the conductive agent.

In some embodiments, the conductive agent is selected from the group consisting of natural graphite particulate, synthetic graphite particulate, hard carbon, soft carbon, mesocarbon microbeads (MCMB), carbon, carbon black, graphite, expanded graphite, graphene, graphene nanoplatelets, carbon fibers, carbon nano-fibers, graphitized carbon flake, carbon tubes, carbon nanotubes, activated carbon, Super P, KS6, vapor grown carbon fibers (VGCF), mesoporous carbon, and combinations thereof.

In some embodiments, the conductive agent comprises a conductive polymer selected from the group consisting of polypyrrole, polyaniline, polyacetylene, polyphenylene sulfide (PPS), polyphenylene vinylene (PPV), poly(3,4-ethylenedioxythiophene) (PEDOT), polythiophene, and combinations thereof. In some embodiments, the conductive polymer plays two roles simultaneously, not only as a conductive agent but also as a binder material. In other embodiments, the conductive agent does not comprise a conductive polymer.

There are no particular limitations on the particular method used to produce the first mixture, except that all the components of the first mixture (e.g., conductive material, cathode active material, binder composition A, aqueous solvent) should be mixed evenly to form a homogeneous mixture. In some embodiments, the first mixture is produced through the use of a homogenizer. Any homogenizer that can reduce or eliminate particle aggregation and/or promote homogeneous distribution of the cathode components can be used herein. Some non-limiting examples of homogenizers include planetary stirring mixers, stirring mixers, blenders, and ultrasonicators. In some embodiments, all the components of the first mixture are added into the homogenizer in a single batch. In other embodiments, each component of the first mixture can be added to the homogenizer in one or more batches, and each batch may comprise one or more components.

There are no particular limitations to the stirring speed, time taken, and temperature used to produce the first mixture, except that they should be sufficient to enable homogeneous dispersion of the first mixture. This would help ensure production of a homogeneous cathode slurry following subsequent steps. As non-limiting examples of suitable conditions used to produce the first mixture, the stirring speed can be in the range of about 100 rpm to about 3,000 rpm; the time taken can be in the range of about 5 minutes to about 24 hours; and the temperature used can be in the range of about 15° C. to about 95° C.

In some embodiments, a second mixture is formed by adding a binder composition B into the first mixture in Step 102.

In some embodiments, the binder composition B comprises a copolymer P₂ as the binder material. In some embodiments, the chemical compositions of the copolymer P₁ and the copolymer P₂ are different. In certain embodiments, the binder composition B further comprises a dispersion medium. There are no particular limitations to the dispersion medium in the binder composition B, but the dispersion medium should be miscible with the aqueous solvent of the cathode slurry, such that the cathode slurry can be homogeneous. Any substance suitable for use as the aqueous solvent of the cathode slurry can also be used as the dispersion medium in binder composition B. In some embodiments, the aqueous solvent of the cathode slurry and the dispersion medium in the binder composition B are the same, are different, or are partially different. In some embodiments, the dispersion medium in the binder composition A and the dispersion medium in the binder composition B are the same, are different, or are partially different.

In some embodiments, the copolymer P₂ comprises the structural units (a₂), (b₂), and (c₂). In some embodiments, the structural unit (a₂) is derived from an acid group-containing monomer. In certain embodiments, the acid group is selected from the group consisting of carboxylic acid, sulfonic acid, sulfuric acid, phosphonic acid, phosphoric acid, nitric acid, and combinations thereof. The acids listed above also include their salts and derivatives. In some embodiments, the salt of the acid comprises an alkali metal cation. In some embodiments, the salt of the acid comprises an ammonium cation. Any embodiments of monomers which structural unit (a₁) is derived from are also suitable embodiments for which structural unit (a₂) is derived from. In certain embodiments, the monomers which structural unit (a₁) and structural unit (a₂) are each derived from respectively are the same, are different, or are partially different.

In some embodiments, the proportion of the structural unit (a₂) within the copolymer P₂ is from about 15% to about 30%, from about 18% to about 30%, from about 20% to about 30%, from about 23% to about 30%, from about 25% to about 30%, from about 28% to about 30%, from about 15% to about 28%, from about 18% to about 28%, from about 20% to about 28%, from about 23% to about 28%, from about 25% to about 28%, from about 15% to about 25%, from about 18% to about 25%, from about 20% to about 25%, from about 23% to about 25%, from about 15% to about 23%, or from about 18% to about 23% by mole, based on the total number of moles of monomeric units in the copolymer.

In some embodiments, the proportion of the structural unit (a₂) within the copolymer P₂ is less than 30%, less than 28%, less than 25%, less than 23%, less than 20%, or less than 18% by mole, based on the total number of moles of monomeric units in the copolymer. In some embodiments, the proportion of the structural unit (a₂) within the copolymer P₂ is more than 15%, more than 18%, more than 20%, more than 23%, more than 25%, or more than 28% by mole, based on the total number of moles of monomeric units in the copolymer.

In some embodiments, the structural unit (b₂) is derived from a monomer selected from the group consisting of an amide group-containing monomer, a hydroxyl group-containing monomer, and combinations thereof. Any embodiments of monomers which structural unit (b₁) is derived from are also suitable embodiments for which structural unit (b₂) is derived from. In certain embodiments, the monomers which structural unit (b₁) and structural unit (b₂) are each derived from respectively are the same, are different, or are partially different.

In some embodiments, the proportion of the structural unit (b₂) within the copolymer P₂ is from about 5% to about 30%, from about 8% to about 30%, from about 10% to about 30%, from about 12% to about 30%, from about 15% to about 30%, from about 18% to about 30%, from about 20% to about 30%, from about 5% to about 28%, from about 8% to about 28%, from about 10% to about 28%, from about 12% to about 28%, from about 15% to about 28%, from about 18% to about 28%, from about 20% to about 28%, from about 5% to about 25%, from about 8% to about 25%, from about 10% to about 25%, from about 12% to about 25%, from about 15% to about 25%, from about 18% to about 25%, from about 5% to about 22%, from about 8% to about 22%, from about 10% to about 22%, from about 12% to about 22%, from about 15% to about 22%, from about 5% to about 20%, from about 8% to about 20%, from about 10% to about 20%, from about 12% to about 20%, from about 15% to about 20%, from about 5% to about 18%, from about 8% to about 18%, from about 10% to about 18%, from about 12% to about 18%, from about 5% to about 15%, from about 8% to about 15%, or from about 5% to about 15% by mole, based on the total number of moles of monomeric units in the copolymer.

In some embodiments, the proportion of the structural unit (b₂) within the copolymer P₂ is less than 30%, less than 28%, less than 25%, less than 22%, less than 20%, less than 18%, less than 15%, less than 12%, less than 10%, or less than 8% by mole, based on the total number of moles of monomeric units in the copolymer. In some embodiments, the proportion of the structural unit (b₂) within the copolymer P₂ is more than 5%, more than 8%, more than 10%, more than 12%, more than 15%, more than 18%, or more than 20% by mole, based on the total number of moles of monomeric units in the copolymer.

In some embodiments, the structural unit (c₂) is derived from a monomer selected from the group consisting of a nitrile group-containing monomer, an ester group-containing monomer, an epoxy group-containing monomer, and combinations thereof. Any embodiments of monomers which structural unit (c₁) is derived from are also suitable embodiments for which structural unit (c₂) is derived from. In certain embodiments, the monomers which structural unit (c₁) and structural unit (c₂) are each derived from respectively are the same, are different, or are partially different.

In some embodiments, the proportion of the structural unit (c₂) within the copolymer P₂ is from about 50% to about 75%, from about 52% to about 75%, from about 55% to about 75%, from about 58% to about 75%, from about 60% to about 75%, from about 62% to about 75%, from about 65% to about 75%, from about 68% to about 75%, from about 70% to about 75%, from about 50% to about 72%, from about 52% to about 72%, from about 55% to about 72%, from about 58% to about 72%, from about 60% to about 72%, from about 62% to about 72%, from about 65% to about 72%, from about 50% to about 70%, from about 52% to about 70%, from about 55% to about 70%, from about 58% to about 70%, from about 60% to about 70%, from about 62% to about 70%, from about 65% to about 70%, from about 50% to about 68%, from about 52% to about 68%, from about 55% to about 68%, from about 58% to about 68%, from about 60% to about 68%, from about 50% to about 65%, from about 52% to about 65%, from about 55% to about 65%, from about 58% to about 65%, from about 60% to about 65%, from about 50% to about 62%, from about 52% to about 62%, from about 55% to about 62%, or from about 50% to about 60% by mole, based on the total number of moles of monomeric units in the copolymer.

In some embodiments, the proportion of the structural unit (c₂) within the copolymer P₂ is less than 75%, less than 72%, less than 70%, less than 68%, less than 65%, less than 62%, less than 60%, less than 58%, or less than 55% by mole, based on the total number of moles of monomeric units in the copolymer. In some embodiments, the proportion of the structural unit (c₂) within the copolymer P₂ is more than 50%, more than 52%, more than 55%, more than 58%, more than 60%, more than 62%, more than 65%, more than 68%, or more than 70% by mole, based on the total number of moles of monomeric units in the copolymer.

In some embodiments, the M_{w} of copolymer P₂ is within the same range as that of copolymer P₁. When the weight-average molecular weight of copolymer P₂ is within this range, the adhesive performance and dispersibility of copolymer P₂ is improved.

In certain embodiments, the solid content of binder composition B is within the same range as that of binder composition A.

In some embodiments, additives are added into the first mixture in Step 102, in addition to the binder composition B. In certain embodiments, the additives may include surfactants, dispersants, flexibility-enhancing additives, salts, ion conductive polymers, and inorganic solid-state electrolytes. The addition of the additives may enhance the properties of a cathode produced from the cathode slurry of the present invention. There are no particular limitations on the particular order of addition into the first mixture, except that all the additives (if any) and the binder composition B should be added into the first mixture.

In some embodiments, the cathode slurry is formed by homogenizing the second mixture in Step 103. The cathode slurry produced as a result of the method disclosed herein comprises a cathode active material, a binder material comprising a copolymer P₁ and a copolymer P₂, and may additionally comprise a conductive agent.

There are no particular limitations to the stirring speed, time taken and temperature used to homogenize the second mixture, except that they should be sufficient to ensure that the cathode slurry formed is homogeneous, and that the cathode components are well dispersed. When the cathode components are well dispersed in the cathode slurry, the resultant electrode layer is homogeneous and smooth, without local unevenness that could affect the performance of the cathode. As non-limiting examples of suitable conditions used to homogenize the second mixture, the stirring speed can be in the range of about 100 rpm to about 3,000 rpm; the time taken can be in the range of about 5 minutes to about 24 hours; and the temperature used can be in the range of about 15° C. to about 95° C.

The structural units (a₁), (a₂), (b₁), and (b₂) are hydrophilic, while the structural units (c₁) and (c₂) are hydrophobic. Accordingly, as it is mostly comprised of structural units (a₁) and (b₁), the copolymer P₁ is hydrophilic and thus has good dispersion in the aqueous solvent of the cathode slurry. Unexpectedly, it was also found that the presence of copolymer P₂ improves battery cycling stability. The method of the present invention therefore requires the use of both the binder composition A and the binder composition B in order to obtain both of the advantages brought about by the use of the respective copolymers.

The order of addition of the binder composition A and the binder composition B is critical. It was found that by adding and dispersing the binder composition A first without adding the binder composition B, the cathode active material (and the conductive agent) can remain well dispersed in the cathode slurry. The binder composition B can then be added and dispersed without affecting the dispersion of the cathode active material (and the conductive agent) in the slurry. A battery produced therefrom would then have good battery cycling stability.

On the other hand, if the binder composition B was added and dispersed first without adding the binder composition A, or both binder compositions were added at once, the cathode components may aggregate. Dispersion of the cathode components in the cathode slurry would be poor. Coating such a cathode slurry onto a substrate would result in a cathode with surface defects, which would negatively affect battery performance. Therefore, the binder composition A should be added and dispersed first before the binder composition B.

The proportion of the copolymer P₁ present in the cathode slurry is critical. If the proportion of the copolymer P₁ was too low, the dispersion of the cathode components in the slurry may be poor. Conversely, if the proportion of the copolymer P₁ was too high, battery cycling stability may be poor.

Similarly, the proportion of the copolymer P₂ present in the cathode slurry is critical. If the proportion of the copolymer P₂ was too low, battery cycling stability may be poor. Conversely, if the proportion of the copolymer P₂ was too high, the dispersion of the cathode components in the slurry may be poor.

In some embodiments, the proportion of each of the copolymer P₁ and the copolymer P₂ in the cathode slurry is independently from about 0.5% to about 3.5%, from about 0.5% to about 2.5%, from about 0.5% to about 2%, from about 0.5% to about 1.5%, from about 1% to about 3%, from about 1% to about 2.8%, from about 1% to about 2.5%, from about 1% to about 2.2%, from about 1% to about 2%, from about 1% to about 1.8%, from about 1% to about 1.5%, from about 1.2% to about 3%, from about 1.2% to about 2.8%, from about 1.2% to about 2.5%, from about 1.2% to about 2.2%, from about 1.2% to about 2%, from about 1.2% to about 1.8%, from about 1.5% to about 3%, from about 1.5% to about 2.8%, from about 1.5% to about 2.5%, from about 1.5% to about 2.2%, from about 1.5% to about 2%, from about 1.8% to about 3%, from about 1.8% to about 2.8%, from about 1.8% to about 2.5%, from about 1.8% to about 2.2%, from about 2% to about 3%, from about 2% to about 2.8%, from about 2% to about 2.5%, from about 2.2% to about 3%, from about 2.2% to about 2.8%, or from about 2.5% to about 3% by weight, based on the solid content of the cathode slurry.

In some embodiments, the proportion of each of the copolymer P₁ and the copolymer P₂ in the cathode slurry is independently less than 3.5%, less than 3.2%, less than 3%, less than 2.8%, less than 2.5%, less than 2%, less than 1.8%, less than 1.5%, less than 1.2%, less than 1%, or less than 0.8% by weight, based on the solid content of the cathode slurry. In some embodiments, the proportion of each of the copolymer P₁ and the copolymer P₂ in the cathode slurry is independently more than 0.5%, more than 0.8%, more than 1%, more than 1.2%, more than 1.5%, more than 1.8%, more than 2%, more than 2.2%, more than 2.5%, or more than 3% by weight, based on the solid content of the cathode slurry.

The proportion of the binder material (i.e., sum of the copolymer P₁ and the copolymer P₂) present in the cathode slurry is also critical. If the proportion of the binder material was too low, electrode layer adhesion and battery cycling stability may be poor. Conversely, if the proportion of the binder material was too high, the conductivity of the cathode may be poor.

In some embodiments, the proportion of the binder material in the cathode slurry is from about 2% to about 5%, from about 2.2% to about 5%, from about 2.5% to about 5%, from about 2.8% to about 5%, from about 3% to about 5%, from about 3.2% to about 5%, from about 3.5% to about 5%, from about 3.8% to about 5%, from about 4% to about 5%, from about 4.2% to about 5%, from about 4.5% to about 5%, from about 2% to about 4.5%, from about 2.2% to about 4.5%, from about 2.5% to about 4.5%, from about 2.8% to about 4.5%, from about 3% to about 4.5%, from about 3.2% to about 4.5%, from about 3.5% to about 4.5%, from about 3.8% to about 4.5%, from about 4% to about 4.5%, from about 2% to about 4%, from about 2.2% to about 4%, from about 2.5% to about 4%, from about 2.8% to about 4%, from about 3% to about 4%, from about 3.2% to about 4%, from about 3.5% to about 4%, from about 2% to about 3.5%, from about 2.2% to about 3.5%, from about 2.5% to about 3.5%, from about 2.8% to about 3.5%, from about 3% to about 3.5%, from about 2% to about 3%, from about 2.2% to about 3%, or from about 2.5% to about 3% by weight, based on the solid content of the cathode slurry.

In some embodiments, the proportion of the binder material in the cathode slurry is less than 5%, less than 4.8%, less than 4.5%, less than 4.2%, less than 4%, less than 3.8%, less than 3.5%, less than 3.2%, less than 3%, less than 2.8%, or less than 2.5% by weight, based on the solid content of the cathode slurry. In some embodiments, the proportion of the binder material in the cathode slurry is more than 2%, more than 2.2%, more than 2.5%, more than 2.8%, more than 3%, more than 3.2%, more than 3.5%, more than 3.8%, more than 4%, more than 4.2%, or more than 4.5% by weight, based on the solid content of the cathode slurry.

In some embodiments, the proportion of the cathode active material in the cathode slurry is from about 75% to about 98%, from about 78% to about 98%, from about 80% to about 98%, from about 82% to about 98%, from about 85% to about 98%, from about 88% to about 98%, from about 90% to about 98%, from about 75% to about 95%, from about 78% to about 95%, from about 80% to about 95%, from about 82% to about 95%, from about 85% to about 95%, from about 75% to about 92%, from about 78% to about 92%, from about 80% to about 92%, from about 82% to about 92%, from about 75% to about 90%, from about 78% to about 90%, from about 80% to about 90%, from about 75% to about 88%, from about 78% to about 88%, or from about 75% to about 85% by weight, based on the solid content of the cathode slurry.

In some embodiments, the proportion of the cathode active material in the cathode slurry is less than 98%, less than 95%, less than 92%, less than 90%, less than 88%, less than 85%, less than 82%, or less than 80% by weight, based on the solid content of the cathode slurry. In some embodiments, the proportion of the cathode active material in the cathode slurry is more than 75%, more than 80%, more than 85%, more than 90%, or more than 95% by weight, based on the solid content of the cathode slurry.

In some embodiments, the proportion of the conductive agent in the cathode slurry from about 1% to about 20%, from about 2% to about 20%, from about 3% to about 20%, from about 4% to about 20%, from about 5% to about 20%, from about 6% to about 20%, from about 7% to about 20%, from about 8% to about 20%, from about 9% to about 20%, from about 10% to about 20%, from about 11% to about 20%, from about 12% to about 20%, from about 13% to about 20%, from about 14% to about 20%, from about 15% to about 20%, from about 1% to about 15%, from about 2% to about 15%, from about 3% to about 15%, from about 4% to about 15%, from about 5% to about 15%, from about 6% to about 15%, from about 7% to about 15%, from about 8% to about 15%, from about 9% to about 15%, from about 10% to about 15%, from about 1% to about 10%, from about 2% to about 10%, from about 3% to about 10%, from about 4% to about 10%, or from about 5% to about 10% by weight, based on the solid content of the cathode slurry.

In some embodiments, the proportion of the conductive agent in the cathode slurry is less than 20%, less than 19%, less than 18%, less than 17%, less than 16%, less than 15%, less than 14%, less than 13%, less than 12%, less than 11%, less than 10%, less than 9%, less than 8%, less than 7%, or less than 6% by weight, based on the solid content of the cathode slurry. In some embodiments, the proportion of the conductive agent in the cathode slurry is more than 1%, more than 2%, more than 3%, more than 4%, more than 5%, more than 6%, more than 7%, more than 8%, more than 9%, more than 10%, more than 11%, more than 12%, more than 13%, more than 14%, or more than 15% by weight, based on the solid content of the cathode slurry.

In some embodiments, the solid content of the cathode slurry is from about 40% to about 80%, from about 40% to about 75%, from about 40% to about 70%, from about 40% to about 65%, from about 40% to about 60%, from about 40% to about 55%, from about 45% to about 80%, from about 45% to about 75%, from about 45% to about 70%, from about 45% to about 65%, from about 45% to about 60%, from about 50% to about 80%, from about 50% to about 75%, from about 50% to about 70%, from about 50% to about 65%, from about 55% to about 80%, from about 55% to about 75%, from about 55% to about 70%, from about 60% to about 80%, from about 60% to about 75%, from about 65% to about 80%, from about 65% to about 75%, or from about 70% to about 80% by weight, based on the total weight of the cathode slurry.

In some embodiments, the solid content of the cathode slurry is less than 80%, less than 75%, less than 70%, less than 65%, less than 60%, less than 55%, or less than 50% by weight, based on the total weight of the cathode slurry. In some embodiments, the solid content of the cathode slurry is more than 40%, more than 45%, more than 50%, more than 55%, more than 60%, more than 65%, or more than 70% by weight, based on the total weight of the cathode slurry.

In certain embodiments, the proportion of water in the non-solid portion of the cathode slurry would be more than 50%. This can be achieved by setting the proportion of water in each of the aqueous solvent, the dispersion medium of binder composition A and the dispersion medium of binder composition B to more than 50% respectively.

In certain embodiments, the proportion of water in the non-solid portion of the cathode slurry is more than 50%, more than 55%, more than 60%, more than 65%, more than 70%, more than 75%, more than 80%, more than 85%, more than 90%, more than 95%, more than 98%, or more than 99%. In some embodiments, the proportion of water in the non-solid portion of the cathode slurry is 100%; i.e., the non-solid portion of the cathode slurry is water.

In some embodiments, after formation of the cathode slurry, the slurry can be coated onto one side or both sides of a current collector to form an electrode layer film. There are no particular limitations to the equipment and the conditions used in coating the cathode slurry, except that a homogeneous and smooth coated layer should be formed as a result. Some non-limiting examples of suitable equipment include a doctor blade coater, a slot-die coater, a transfer coater, a spray coater, a roll coater, a gravure coater, a dip coater, or a curtain coater.

The current collector acts to collect electrons generated by electrochemical reactions of the cathode active material or to supply electrons required for the electrochemical reactions. There are no particular limitations on the current collector. In some embodiments, the current collector can be in the form of a foil, sheet or film. In some embodiments, the current collector is a metal. In some embodiments, the metal is selected from the group consisting of stainless steel, titanium, nickel, aluminum, copper, platinum, gold, silver, chromium, zirconium, tungsten, molybdenum, silicon, tin, vanadium, zinc, cadmium, or alloys thereof. In some embodiments, the current collector further comprises an electrically-conductive resin.

In some embodiments, following the coating of the cathode slurry onto a current collector, the electrode layer film is heated and dried to form the electrode layer, and a cathode is produced. Any equipment that can dry the electrode layer film to affix the electrode layer to the current collector can be used herein. Some non-limiting examples of suitable drying equipment include a vacuum drying oven, batch drying oven, a conveyor drying oven, and a microwave drying oven. There are no particular limitations to the conditions used to dry the electrode layer film, except that the drying conditions should be sufficient to ensure that the electrode layer adheres strongly to the current collector. However, drying the conductive layer film at temperatures above 150° C. may result in undesirable deformation of the cathode, thus affecting the cathode's performance. In some embodiments, the cathode is compressed mechanically following drying in order to increase the density of the cathode.

In certain embodiments, the thickness of the electrode layer is from about 5 μm to about 90 μm, from about 5 μm to about 50 μm, from about 5 μm to about 25 μm, from about 10 μm to about 90 μm, from about 10 μm to about 50 μm, from about 10 μm to about 30 μm, from about 25 μm to about 70 μm, from about 25 μm to about 50 μm, from about 30 μm to about 90 am, or from about 30 μm to about 80 μm. In some embodiments, the thickness of the electrode layer is more than 5 μm, more than 10 μm, more than 15 μm, more than 20 μm, more than 25 am, more than 30 μm, more than 40 μm, more than 50 μm, more than 60 μm, more than 70 μm, or more than 80 μm. In some embodiments, the thickness of the electrode layer is less than 90 am, less than 80 μm, less than 70 μm, less than 60 μm, less than 50 μm, less than 40 μm, less than 30 μm, less than 25 μm, less than 20 μm, less than 15 μm, or less than 10 μm.

In some embodiments, the surface density of the electrode layer is from about 1 mg/cm² to about 50 mg/cm², from about 2.5 mg/cm² to about 50 mg/cm², from about 5 mg/cm² to about 50 mg/cm², from about 10 mg/cm² to about 50 mg/cm², from about 15 mg/cm² to about 50 mg/cm², from about 20 mg/cm² to about 50 mg/cm², from about 30 mg/cm² to about 50 mg/cm², from about 1 mg/cm² to about 30 mg/cm², from about 5 mg/cm² to about 30 mg/cm², from about 10 mg/cm² to about 30 mg/cm², from about 15 mg/cm² to about 30 mg/cm², from about 20 mg/cm² to about 30 mg/cm², from about 1 mg/cm² to about 20 mg/cm², from about 5 mg/cm² to about 20 mg/cm², from about 10 mg/cm² to about 20 mg/cm², from about 1 mg/cm² to about 15 mg/cm², from about 5 mg/cm² to about 15 mg/cm², or from about 10 mg/cm² to about 15 mg/cm².

In some embodiments, the surface density of the electrode layer is less than 50 mg/cm², less than 40 mg/cm², less than 30 mg/cm², less than 20 mg/cm², less than 15 mg/cm², less than 10 mg/cm², less than 5 mg/cm², or less than 2.5 mg/cm². In some embodiments, the surface density of the electrode layer is more than 1 mg/cm², more than 2.5 mg/cm², more than 5 mg/cm², more than 10 mg/cm², more than 15 mg/cm², more than 20 mg/cm², more than 30 mg/cm², or more than 40 mg/cm².

The electrode layer of the present invention exhibits strong adhesion to the current collector. It is important for the electrode layer to have a high peeling strength with respect to the current collector, as this prevents delamination or separation of the cathode, which would greatly impact the mechanical stability of the cathode and the cycling stability of a battery comprising the cathode. Therefore, the cathodes should have sufficient peeling strength to withstand the rigors of battery manufacture.

In some embodiments, the peeling strength between the electrode layer and the current collector is from about 1.0 N/cm to about 8.0 N/cm, from about 1.0 N/cm to about 6.0 N/cm, from about 1.0 N/cm to about 5.0 N/cm, from about 1.0 N/cm to about 4.0 N/cm, from about 1.0 N/cm to about 3.0 N/cm, from about 1.0 N/cm to about 2.5 N/cm, from about 1.0 N/cm to about 2.0 N/cm, from about 2.0 N/cm to about 8.0 N/cm, from about 2.0 N/cm to about 6.0 N/cm, from about 2.0 N/cm to about 5.0 N/cm, from about 2.0 N/cm to about 3.0 N/cm, from about 3.0 N/cm to about 8.0 N/cm, from about 3.0 N/cm to about 6.0 N/cm, or from about 4.0 N/cm to about 6.0 N/cm.

In some embodiments, the peeling strength between the electrode layer and the current collector is more than 1.0 N/cm, more than 1.2 N/cm, more than 1.5 N/cm, more than 2.0 N/cm, more than 2.2 N/cm, more than 2.5 N/cm, more than 3.0 N/cm, more than 3.5 N/cm, more than 4.0 N/cm, more than 4.5 N/cm, more than 5.0 N/cm, more than 5.5 N/cm, more than 6.0 N/cm, more than 6.5 N/cm, or more than 7.0 N/cm. In some embodiments, the peeling strength between the electrode layer and the current collector is less than 8.0 N/cm, less than 7.5 N/cm, less than 7.0 N/cm, less than 6.5 N/cm, less than 6.0 N/cm, less than 5.5 N/cm, less than 5.0 N/cm, less than 4.5 N/cm, less than 4.0 N/cm, less than 3.5 N/cm, less than 3.0 N/cm, less than 2.8 N/cm, less than 2.5 N/cm, less than 2.2 N/cm, less than 2.0 N/cm, less than 1.8 N/cm, or less than 1.5 N/cm.

In some embodiments, once a cathode is formed, the cathode can be assembled with an anode and an electrolyte to form a battery. There are no particular limitations to the anode or the electrolyte used, as long as the battery has good electrochemical performance.

In some embodiments, the electrolyte is a liquid electrolyte. Such a liquid electrolyte comprises an electrolyte solvent and a salt. In some embodiments, the electrolyte solvent is water; the liquid electrolyte is then an aqueous electrolyte. In other embodiments, the electrolyte solvent is a liquid composed of one or more organic solvents; the liquid electrolyte is then a non-aqueous electrolyte. In some embodiments, each organic solvent is selected from a carbonate-based, ester-based, ether-based or other aprotic solvent. Some non-limiting examples of the carbonate-based solvent include dimethyl carbonate, diethyl carbonate, dipropyl carbonate, methylpropyl carbonate, ethylpropyl carbonate, ethyl methyl carbonate, ethylene carbonate, propylene carbonate, butylene carbonate, and combinations thereof. Some non-limiting examples of the ester-based solvent include methyl acetate, methyl propanoate, ethyl acetate, n-propyl acetate, dimethyl acetate, methyl propionate, ethyl propionate, and combinations thereof. Some non-limiting examples of the ether-based solvent include dibutyl ether, tetraglyme, diglyme, dimethoxyethane, 2-methyltetrahydrofuran, tetrahydrofuran, and combinations thereof. Some non-limiting examples of the other aprotic solvent include methyl bromide, ethyl bromide, methyl formate, acetonitrile, dimethyl sulfoxide, dimethylformamide, N-methyl-2-pyrrolidone, and combinations thereof.

In some embodiments, the liquid electrolyte is for a lithium-ion battery. The salt in the liquid electrolyte is then a lithium salt. In some embodiments, the lithium salt is selected from the group consisting of LiPF₆, LiBO₂, LiBF₄, LiSbF₆, LiAsF₆, LiAlCl₄, LiClO₄, LiCl, LiI, LiNO₃, LiB(C₂O₄)₂, LiSO₃CF₃, LiN(SO₂F)₂, LiN(SO₂CF₃)₂, LiN(SO₂CF₂CF₃)₂, LiC₂H₃O₂, and combinations thereof.

In some embodiments, the liquid electrolyte is for a sodium-ion battery. The salt in the liquid electrolyte is then a sodium salt. In some embodiments, the sodium salt is the sodium analogue of the lithium salts discussed above, with the lithium replaced by sodium. Such sodium salts include NaPF₆, NaBF₄, NaN(SO₂CF₃)₂, NaN(SO₂F)₂, NaClO₄, NaSO₃CF₃, and combinations thereof. In some embodiments, the salt present in the liquid electrolyte for a sodium-ion battery is one or more of NaMFx; wherein each x is 4 or 6; and wherein each M is selected from the group consisting of Al³⁺, B³⁺, Ga³⁺, In³⁺, Sc³⁺, Y³⁺, La³⁺, P⁵⁺, As⁵⁺, and combinations thereof.

In some embodiments, the electrolyte is a solid-state electrolyte. In some embodiments, the solid-state electrolyte is a polymer electrolyte. Such a polymer electrolyte comprises an ion-conductive polymer as well as a salt. Any known polymer electrolyte can be used in the invention disclosed herein. Some non-limiting examples of the ion-conductive polymer include polyether, polycarbonate, polyacrylate, polysiloxane, polyphosphazene, polyethylene derivative, alkylene oxide derivative, phosphate polymer, poly-lysine, polyester sulfide, polyvinyl alcohol, and polyvinylidene fluoride. Some non-limiting examples of the salt of the polymer electrolyte include the lithium and sodium salts mentioned above for the liquid electrolyte.

In some embodiments, the solid-state electrolyte is an inorganic solid-state electrolyte. Any known inorganic solid-state electrolyte can be used. Some non-limiting examples include sulfides, lithium superionic conductor (LISICON) type compounds, lithium lanthanum titanate (LLTO) type compounds, and perovskite compounds.

In some embodiments, the solid-state electrolyte is a gel electrolyte. Such a gel electrolyte comprises a polymer electrolyte and an electrolyte solvent.

When the method disclosed herein is used to produce a cathode slurry, the cathode slurry is well dispersed. Following coating of the slurry to form a cathode, a battery comprising the cathode would have good cycling stability. Accordingly, the method of the present invention successfully produces a cathode slurry that can reconcile both slurry processibility and battery electrochemical performance.

The following examples are presented to exemplify embodiments of the invention but are not intended to limit the invention to the specific embodiments set forth. Unless indicated to the contrary, all parts and percentages are by weight. All numerical values are approximate. When numerical ranges are given, it should be understood that embodiments outside the stated ranges may still fall within the scope of the invention. Specific details described in each example should not be construed as necessary features of the invention.

### EXAMPLES

The solid content of a binder composition can be determined by measuring the extent of mass change of the binder composition before and after drying. Approximately 1 g of the binder composition was weighed in a weighing bottle and dried at 110±5° C. and −0.09 MPa for more than 5 hours by a vacuum dryer. The binder composition was cooled in a desiccator for about 15 minutes and then its mass was measured. The difference in mass of the binder composition before and after the drying was determined, and the solid content (%) of the binder composition was calculated according to the following formula:

$$Solid content = \frac{Mass of binder composition after drying}{Mass of binder composition before drying} \times 100 \%$$

The interfacial resistance between the electrode layer and the current collector of an electrode was measured using an electrode resistance measurement system (RM2610, HIOKI).

The weight-average molecular weight of the copolymer was measured by gel permeation chromatography. A binder composition comprising the copolymer was first dissolved in dimethylformamide at room temperature. Once dissolution of the binder composition was complete, the solution was gently filtered through a 0.45 μm filter to prepare a measurement sample. A polystyrene standard was used to prepare a calibration curve against which the weight-average molecular weight of the copolymer was calculated. The obtained measurement sample was analyzed with an Agilent PLgel 5 μm MIXED-C column. The flow rate was 1 ml/min and the weight of the sample was 2 mg. The detector used was Waters 2414 Refractive Index (RI) Detector and the detection temperature was 35° C.

### Example 1

### A) Preparation of the Binder Composition A

18.17 g of sodium hydroxide (NaOH) was added into a round-bottomed flask containing 380 g of de-ionized water. The mixture was stirred at 80 rpm for 30 mins to obtain a first suspension.

36.08 g of acrylic acid was added into the first suspension. The mixture was further stirred at 80 rpm for 30 mins to obtain a second suspension.

19.05 g of acrylamide was dissolved in 10 g of DI water to form an acrylamide solution. Thereafter, all of the acrylamide solution was added into the second suspension. The mixture was further heated to 55° C. and stirred at 80 rpm for 45 mins to obtain a third suspension.

12.88 g of acrylonitrile was added into the third suspension. The mixture was further stirred at 80 rpm for 10 mins to obtain a fourth suspension.

Further, 0.015 g of water-soluble free radical initiator (ammonium persulfate, APS; obtained from Aladdin Industries Corporation, China) was dissolved in 3 g of DI water and 0.0075 g of reducing agent (sodium bisulfite; obtained from Tianjin Damao Chemical Reagent Factory, China) was dissolved in 1.5 g of DI water. All of the APS solution and the sodium bisulfite solution were added into the fourth suspension. The mixture was stirred at 200 rpm for 24 h at 55° C. to obtain a fifth suspension.

After the complete reaction, the temperature of the fifth suspension was lowered to 25° C. 3.72 g of NaOH was dissolved in 400 g of DI water. Thereafter, all of the sodium hydroxide solution was added dropwise into the fifth suspension for 1 h to adjust pH to 7.3 to form the sixth suspension. The sixth suspension was filtered using 200 μm nylon mesh to form the binder composition A. The solid content of the binder composition A was 9.00 wt. %.

### B) Preparation of the Binder Composition B

A binder composition B was prepared in the same manner as that of the binder composition A, except that 7.45 g of NaOH was added in the preparation of the first suspension, 16.76 g of acrylic acid was added in the preparation of the second suspension, 7.19 g of acrylamide was added in the preparation of the third suspension and 35.96 g of acrylonitrile was added in the preparation of the fourth suspension. The solid content of the binder composition B was 8.07 wt. %.

### C) Preparation of the Cathode Slurry

A first mixture was prepared by dispersing 3.00 g of the conductive agent (Super P; obtained from Timcal Ltd, Bodio, Switzerland), 55.80 g of NMC811 (obtained from Shandong Tianjiao New Energy Co., Ltd, China) and 6.67 g of the binder composition A (9.00 wt. % solid content) in 27.10 g of deionized water while stirring with an overhead stirrer (R20, IKA). After the addition, the first mixture was further stirred for about 2.5 hours at 25° C. at a speed of 1,200 rpm.

Thereafter, a second mixture was prepared by adding 7.43 g of the binder composition B (8.07 wt. % solid content) while stirring with the overhead stirrer.

Then, the second mixture was further stirred for about 30 minutes at 25° C. at a speed of 1,200 rpm to form a cathode slurry.

### D) Preparation of the Cathode

The homogenized cathode slurry was coated onto one side of an aluminum foil having a thickness of 16 μm as a current collector using a doctor blade coater with a gap width of 120 μm. The coated slurry of 80 μm on the aluminum foil was dried to form an electrode layer by an electrically heated oven at 70° C. The drying time was about 10 minutes. The electrode was then pressed to decrease the thickness of the electrode layer to 23 μm. The surface density of the electrode layer is 7.00 mg/cm².

The interfacial resistance between the electrode layer and the current collector in the cathode was measured.

### E) Assembly of Coin Cell

CR2032 coin-type Li cells were assembled in an argon-filled glove box. A lithium metal foil having a thickness of 500 μm was used as the anode. The cathode was cut into disc-form and dried in a box-type resistance oven under vacuum (DZF-6020, obtained from Shenzhen Kejing Star Technology Co. Ltd., China) at 105° C. for about 16 hours. The cathode and anode were kept apart by a separator. The separator was a ceramic-coated microporous membrane made of nonwoven fabric (MPM, Japan), which had a thickness of about 25 μm.

An electrolyte was then injected into the case holding the packed electrodes under a high-purity argon atmosphere with a moisture and oxygen content of less than 3 ppm respectively. The electrolyte was a solution of LiPF₆ (1 M) in a mixture of ethylene carbonate (EC), ethyl methyl carbonate (EMC) and dimethyl carbonate (DMC) at a volume ratio of 1:1:1. After electrolyte filling, the coin cell was sealed using a punch tooling with a standard circular shape.

### F) Electrochemical Measurements

The coin cells were analyzed in a constant current mode using a multi-channel battery tester (BTS-4008-5V10 mA, obtained from Neware Electronics Co. Ltd, China). After activation at C/20 was completed, they were charged and discharged at a rate of C/2. The charging/discharging cycling tests of the cells were performed between 3.0 and 4.3 V at a current density of C/2 at 25° C. to obtain the discharge capacity and the capacity retention after 50 cycles. The electrochemical performance of the coin cell of Example 1 was measured and is shown in Table 1 below.

### Preparation of the Binder Compositions a of Examples 2-5 and 9-14 and Comparative Examples 2-7 and 9

The binder compositions A of Examples 2-5 and 9-14 and Comparative Examples 2-7 and 9 were prepared in the same manner as in Example 1.

### Preparation of the Binder Composition A of Example 6

The binder composition A was prepared in the same manner as in Example 1, except that 29.70 g of NaOH was added in the preparation of the first suspension, 56.85 g of acrylic acid was added in the preparation of the second suspension, 7.19 g of acrylamide was added in the preparation of the third suspension and 6.44 g of acrylonitrile was added in the preparation of the fourth suspension. The solid content of the binder composition was 10.40 wt. %.

### Preparation of the Binder Composition A of Example 7

The binder composition A was prepared in the same manner as in Example 1, except that 17.56 g of NaOH was added in the preparation of the first suspension, 34.99 g of acrylic acid was added in the preparation of the second suspension, 12.94 g of acrylamide was added in the preparation of the third suspension and 18.25 g of acrylonitrile was added in the preparation of the fourth suspension. The solid content of the binder composition was 9.19 wt. %.

### Preparation of the Binder Composition A of Example 8

The binder composition A was prepared in the same manner as in Example 1, except that 18.37 g of NaOH was added in the preparation of the first suspension, 36.44 g of acrylic acid was added in the preparation of the second suspension, 23.01 g of acrylamide was added in the preparation of the third suspension and 9.66 g of acrylonitrile was added in the preparation of the fourth suspension. The solid content of the binder composition was 9.37 wt. %.

### Preparation of the Binder Composition A of Comparative Example 1

The binder composition A was prepared in the same manner as the binder composition B of Example 1.

### Preparation of the Binder Compositions B of Examples 2-8 and 13-14 and Comparative Examples 2-8

The binder compositions B of Examples 2-8 and 13-14 and Comparative Examples 2-8 were prepared in the same manner as in Example 1.

### Preparation of the Binder Composition B of Example 9

The binder composition B was prepared in the same manner as in Example 1, except that 9.47 g of NaOH was added in the preparation of the first suspension, 20.41 g of acrylic acid was added in the preparation of the second suspension, 3.59 g of acrylamide was added in the preparation of the third suspension and 35.96 g of acrylonitrile was added in the preparation of the fourth suspension. The solid content of the binder composition was 7.89 wt. %.

### Preparation of the Binder Composition B of Example 10

The binder composition B was prepared in the same manner as in Example 1, except that 5.42 g of NaOH was added in the preparation of the first suspension, 13.12 g of acrylic acid was added in the preparation of the second suspension, 12.94 g of acrylamide was added in the preparation of the third suspension and 34.35 g of acrylonitrile was added in the preparation of the fourth suspension. The solid content of the binder composition was 7.82 wt. %.

### Preparation of the Binder Composition B of Example 11

The binder composition B was prepared in the same manner as in Example 1, except that 7.04 g of NaOH was added in the preparation of the first suspension, 16.04 g of acrylic acid was added in the preparation of the second suspension, 17.97 g of acrylamide was added in the preparation of the third suspension and 28.45 g of acrylonitrile was added in the preparation of the fourth suspension. The solid content of the binder composition was 7.79 wt. %.

### Preparation of the Binder Composition B of Example 12

The binder composition B was prepared in the same manner as in Example 1, except that 6.23 g of NaOH was added in the preparation of the first suspension, 14.58 g of acrylic acid was added in the preparation of the second suspension, 5.75 g of acrylamide was added in the preparation of the third suspension and 38.64 g of acrylonitrile was added in the preparation of the fourth suspension. The solid content of the binder composition was 7.58 wt. %.

### Preparation of the Binder Composition B of Comparative Example 1

The binder composition B was prepared in the same manner as the binder composition A of Example 1.

### Preparation of the Cathode Slurry of Example 2

The cathode slurry was prepared in the same manner as in Example 1, except that 2.40 g of the conductive agent, 55.80 g of NMC811 and 13.33 g of the binder composition A were dispersed in 21.03 g of deionized water to prepare the first mixture.

### Preparation of the Cathode Slurry of Example 3

The cathode slurry was prepared in the same manner as in Example 1, except that 1.80 g of the conductive agent, 55.80 g of NMC811 and 6.67 g of the binder composition A were dispersed in 13.43 g of deionized water to prepare the first mixture, and 22.30 g of the binder composition B was added to the first mixture to prepare the second mixture.

### Preparation of the Cathode Slurry of Example 4

The cathode slurry was prepared in the same manner as in Example 1, except that 1.80 g of the conductive agent, 55.80 g of NMC811 and 20.00 g of the binder composition A were dispersed in 14.97 g of deionized water to prepare the first mixture.

### Preparation of the Cathode Slurry of Example 5

The cathode slurry was prepared in the same manner as in Example 1, except that 1.50 g of the conductive agent, 55.74 g of NMC811 and 15.33 g of the binder composition A were dispersed in 9.22 g of deionized water to prepare the first mixture, and 18.21 g of the binder composition B was added to the first mixture to prepare the second mixture.

### Preparation of the Cathode Slurry of Example 6

The cathode slurry was prepared in the same manner as in Example 1, except that 2.40 g of the conductive agent, 55.80 g of NMC811 and 11.54 g of the binder composition A were dispersed in 22.83 g of deionized water to prepare the first mixture.

### Preparation of the Cathode Slurry of Example 7

The cathode slurry was prepared in the same manner as in Example 1, except that 2.40 g of the conductive agent, 55.80 g of NMC811 and 13.06 g of the binder composition A were dispersed in 21.31 g of deionized water to prepare the first mixture.

### Preparation of the Cathode Slurry of Example 8

The cathode slurry was prepared in the same manner as in Example 1, except that 2.40 g of the conductive agent, 55.80 g of NMC811 and 12.81 g of the binder composition A were dispersed in 21.56 g of deionized water to prepare the first mixture.

### Preparation of the Cathode Slurry of Example 9

The cathode slurry was prepared in the same manner as in Example 2, except that the conductive agent, the NMC811 and the binder composition A were dispersed in 20.86 g of deionized water to prepare the first mixture, and 7.60 g of the binder composition B was added to the first mixture to prepare the second mixture.

### Preparation of the Cathode Slurry of Example 10

The cathode slurry was prepared in the same manner as in Example 2, except that the conductive agent, the NMC811 and the binder composition A were dispersed in 20.79 g of deionized water to prepare the first mixture, and 7.67 g of the binder composition B was added to the first mixture to prepare the second mixture.

### Preparation of the Cathode Slurry of Example 11

The cathode slurry was prepared in the same manner as in Example 2, except that the conductive agent, the NMC811 and the binder composition A were dispersed in 20.76 g of deionized water to prepare the first mixture, and 7.70 g of the binder composition B was added to the first mixture to prepare the second mixture.

### Preparation of the Cathode Slurry of Example 12

The cathode slurry was prepared in the same manner as in Example 2, except that the conductive agent, the NMC811 and the binder composition A were dispersed in 20.55 g of deionized water to prepare the first mixture, and 7.92 g of the binder composition B was added to the first mixture to prepare the second mixture.

### Preparation of the Cathode Slurry of Example 13

The cathode slurry was prepared in the same manner as in Example 1, except that 55.80 g of NMC811 was replaced with NMC622 of the same weight (obtained from Shandong Tianjiao New Energy Co., Ltd, China).

### Preparation of the Cathode Slurry of Example 14

The cathode slurry was prepared in the same manner as in Example 1, except that 55.80 g of NMC811 was replaced with LiNi_{0.5}Mn_{1.5}O₄(LNMO; obtained from Chengdu Xingneng New Materials Co. Ltd, China) of the same weight.

### Preparation of the Cathode Slurry of Comparative Example 1

The cathode slurry was prepared in the same manner as in Example 1, except that 3.00 g of the conductive agent, 55.80 g of NMC811 and 7.43 g of the binder composition A were dispersed in 27.10 g of deionized water to prepare the first mixture, and 6.67 g of the binder composition B was added to the first mixture to prepare the second mixture.

### Preparation of the Cathode Slurry of Comparative Example 2

The cathode slurry was prepared in the same manner as in Example 1, except that 3.00 g of the conductive agent, 55.80 g of NMC811 and 2.00 g of the binder composition A were dispersed in 26.56 g of deionized water to prepare the first mixture, and 12.64 g of the binder composition B was added to the first mixture to prepare the second mixture.

### Preparation of the Cathode Slurry of Comparative Example 3

The cathode slurry was prepared in the same manner as in Example 1, except that 3.00 g of the conductive agent, 55.80 g of NMC811 and 11.33 g of the binder composition A were dispersed in 27.64 g of deionized water to prepare the first mixture, and 2.23 g of the binder composition B was added to the first mixture to prepare the second mixture.

### Preparation of the Cathode Slurry of Comparative Example 4

The cathode slurry was prepared in the same manner as in Example 1, except that 1.50 g of the conductive agent, 55.80 g of NMC811 and 24.67 g of the binder composition A were dispersed in 12.09 g of deionized water to prepare the first mixture, and 5.95 g of the binder composition B was added to the first mixture to prepare the second mixture.

### Preparation of the Cathode Slurry of Comparative Example 5

The cathode slurry was prepared in the same manner as in Example 1, except that 1.50 g of the conductive agent, 55.80 g of NMC811 and 5.33 g of the binder composition A were dispersed in 9.86 g of deionized water to prepare the first mixture, and 27.51 g of the binder composition B was added to the first mixture to prepare the second mixture.

### Preparation of the Cathode Slurry of Comparative Example 6

The cathode slurry was prepared in the same manner as in Example 1, except that 1.50 g of the conductive agent, 55.38 g of NMC811 and 17.33 g of the binder composition A were dispersed in 6.46 g of deionized water to prepare the first mixture, and 19.33 g of the binder composition B was added to the first mixture to prepare the second mixture.

### Preparation of the Cathode Slurry of Comparative Example 7

A pre-mixture was prepared by mixing 6.67 g of the binder composition A and 7.43 g of the binder composition B. The pre-mixture was then stirred using an overhead stirrer for about 30 minutes at 25° C. at a speed of 1,200 rpm.

A first mixture was prepared by dispersing 3.00 g of the conductive agent, 55.80 g of NMC811 and the pre-mixture in 27.10 g of deionized water while stirring with an overhead stirrer. After the addition, the first mixture was further stirred for about 2.5 hours at 25° C. at a speed of 1,200 rpm to form the cathode slurry.

### Preparation of the Cathode Slurry of Comparative Example 8

A 45% sodium polyacrylate solution (Sigma-Aldrich, USA) was used as the binder composition A. The cathode slurry was then prepared in the same manner as in Example 1, except that 3.00 g of the conductive agent, 55.80 g of NMC811 and 1.33 g of the binder composition A were dispersed in 32.43 g of deionized water to prepare the first mixture.

### Preparation of the Cathode Slurry of Comparative Example 9

A 45% sodium polyacrylate solution (Sigma-Aldrich, USA) was used as the binder composition B. The cathode slurry was prepared in the same manner as in Example 1, except that the conductive agent, NMC811 and binder composition A were dispersed in 33.20 g of deionized water to prepare the first mixture, and 1.33 g of the binder composition B was added to the first mixture to prepare the second mixture.

### Preparation of Positive Electrodes of Examples 2-14 and Comparative Examples 1-9

The positive electrodes of Examples 2-14 and Comparative Examples 1-9 were prepared in the same manner as in Example 1.

### Assembly of Coin Cells of Examples 2-14 and Comparative Examples 1-9

The coin cells of Examples 2-14 and Comparative Examples 1-9 were assembled in the same manner as in Example 1.

### Electrochemical Measurements of Examples 2-14 and Comparative Examples 1-9

The electrochemical performance of the coin cells of Examples 2-14 and Comparative Examples 1-9 were measured in the same manner as in Example 1 and the test results are shown in Table 1 below.

While the invention has been described with respect to a limited number of embodiments, the specific features of one embodiment should not be attributed to other embodiments of the invention. In some embodiments, the methods may include numerous steps not mentioned herein. In other embodiments, the methods do not include, or are substantially free of, any steps not enumerated herein. Variations and modifications from the described embodiments exist. The appended claims intend to cover all those modifications and variations as falling within the scope of the invention.

| | Copolymer P₁ | | | | Copolymer P₂ | | | | | | 0.5 C | Capacity |
|---|---|---|---|---|---|---|---|---|---|---|---|---|
| | Proportion of | | | | Proportion of | | | | | | Initial | retention |
| | structural units | | | Proportion | structural units | | | Proportion | Cathode | Interfacial | discharging | after 50 |
| | (mol %) | | | in slurry | (mol %) | | | in slurry | active | resistance | capacity | cycles |
| | (a₁) | (b₁) | (c₁) | (wt. %) | (a₂) | (b₂) | (c₂) | (wt. %) | material | (Ω · cm²) | (mAh/g) | (%) |
| Example 1 | 49.5 | 26.5 | 24 | 1 | 23 | 10 | 67 | 1 | NMC811 | 0.51 | 194.5 | 89.2 |
| Example 2 | 49.5 | 26.5 | 24 | 2 | 23 | 10 | 67 | 1 | NMC811 | 0.59 | 194.1 | 89.7 |
| Example 3 | 49.5 | 26.5 | 24 | 1 | 23 | 10 | 67 | 3 | NMC811 | 0.76 | 191.9 | 87.5 |
| Example 4 | 49.5 | 26.5 | 24 | 3 | 23 | 10 | 67 | 1 | NMC811 | 0.88 | 190.4 | 86.3 |
| Example 5 | 49.5 | 26.5 | 24 | 2.3 | 23 | 10 | 67 | 2.3 | NMC811 | 0.79 | 192.5 | 88.2 |
| Example 6 | 78 | 10 | 12 | 2 | 23 | 10 | 67 | 1 | NMC811 | 0.57 | 193.3 | 88.4 |
| Example 7 | 48 | 18 | 34 | 2 | 23 | 10 | 67 | 1 | NMC811 | 0.63 | 193.1 | 87.9 |
| Example 8 | 50 | 32 | 18 | 2 | 23 | 10 | 67 | 1 | NMC811 | 0.73 | 192.4 | 89.0 |
| Example 9 | 49.5 | 26.5 | 24 | 2 | 28 | 5 | 57 | 1 | NMC811 | 0.68 | 193.7 | 88.1 |
| Example 10 | 49.5 | 26.5 | 24 | 2 | 18 | 18 | 64 | 1 | NMC811 | 0.69 | 192.9 | 87.8 |
| Example 11 | 49.5 | 26.5 | 24 | 2 | 22 | 25 | 53 | 1 | NMC811 | 0.65 | 194.1 | 88.4 |
| Example 12 | 49.5 | 26.5 | 24 | 2 | 20 | 8 | 72 | 1 | NMC811 | 0.71 | 193.0 | 88.9 |
| Example 13 | 49.5 | 26.5 | 24 | | 23 | 10 | 67 | 1 | NMC622 | 0.53 | 159.1 | 87.8 |
| Example 14 | 49.5 | 26.5 | 24 | 1 | 23 | 10 | 67 | 1 | LNMO | 0.51 | 120.9 | 89.1 |
| Comparative Example 1 | 23 | 10 | 67 | 1 | 49.5 | 26.5 | 24 | 1 | NMC811 | 2.88 | 181.2 | 76.4 |
| Comparative Example 2 | 49.5 | 26.5 | 24 | 0.3 | 23 | 10 | 67 | 1.7 | NMC811 | 1.75 | 181.1 | 78.5 |
| Comparative Example 3 | 49.5 | 26.5 | 24 | 1.7 | 23 | 10 | 67 | 0.3 | NMC811 | 1.91 | 177.2 | 74.7 |
| Comparative Example 4 | 49.5 | 26.5 | 24 | 3.7 | 23 | 10 | 67 | 0.8 | NMC811 | 4.55 | 172.3 | 72.3 |
| Comparative Example 5 | 49.5 | 26.5 | 24 | 0.8 | 23 | 10 | 67 | 3.7 | NMC811 | 4.07 | 175.2 | 71.1 |
| Comparative Example 6 | 49.5 | 26.5 | 24 | 2.6 | 23 | 10 | 67 | 2.6 | NMC811 | 5.34 | 171.3 | 70.1 |
| Comparative Example 7 | 49.5 | 26.5 | 24 | 1 | 23 | 10 | 67 | 1 | NMC811 | 2.87 | 180.1 | 75.6 |
| Comparative Example 8 | 100 | 0 | 0 | 1 | 23 | 10 | 67 | 1 | NMC811 | 1.72 | 177.9 | 78.6 |
| Comparative Example 9 | 49.5 | 26.5 | 24 | 1 | 100 | 0 | 0 | 1 | NMC811 | 1.94 | 178.3 | 77.1 |

What is claimed is:

1. A method of preparing a cathode slurry for a secondary battery, comprising the steps of:
1) dispersing a binder composition A and a cathode active material in an aqueous solvent to form a first mixture;
2) adding a binder composition B into the first mixture to form a second mixture; and
3) homogenizing the second mixture to obtain the cathode slurry;
wherein the binder composition A comprises a copolymer P₁, and the binder composition B comprises a copolymer P₂; wherein the copolymer P₁ comprises a structural unit (a₁), a structural unit (b₁), and a structural unit (c₁); wherein the copolymer P₂ comprises a structural unit (a₂), a structural unit (b₂), and a structural unit (c₂); wherein each of the structural unit (a₁) and the structural unit (a₂) is independently derived from a monomer containing an acid group; wherein each of the structural unit (b₁) and the structural unit (b₂) is independently derived from a monomer selected from the group consisting of an amide group-containing monomer, a hydroxyl group-containing monomer, and combinations thereof; and wherein each of the structural unit (c₁) and the structural unit (c₂) is independently derived from a monomer selected from the group consisting of a nitrile group-containing monomer, an ether group-containing monomer, an epoxy group-containing monomer, and combinations thereof.

2. The method according to claim 1, wherein the acid group is selected from the group consisting of carboxylic acid, sulfonic acid, sulfuric acid, phosphonic acid, phosphoric acid, nitric acid, their salts, their derivatives, and combinations thereof.

3. The method according to claim 1, wherein the chemical compositions of the copolymer P₁ and the copolymer P₂ are different.

4. The method according to claim 1, wherein the proportion of the structural unit (a₁) in the copolymer P₁ is from about 45% to about 80% by mole, based on the total number of moles of monomeric units in the copolymer P₁.

5. The method according to claim 1, wherein the proportion of the structural unit (a₂) in the copolymer P₂ is from about 15% to about 30% by mole, based on the total number of moles of monomeric units in the copolymer P₂.

6. The method according to claim 1, wherein the proportion of the structural unit (b₁) in the copolymer P₁ is from about 10% to about 35% by mole, based on the total number of moles of monomeric units in the copolymer P₁.

7. The method according to claim 1, wherein the proportion of the structural unit (b₂) in the copolymer P₂ is from about 5% to about 30% by mole, based on the total number of moles of monomeric units in the copolymer P₂.

8. The method according to claim 1, wherein the proportion of the structural unit (c₁) in the copolymer P₁ is from about 10% to about 40% by mole, based on the total number of moles of monomeric units in the copolymer P₁.

9. The method according to claim 1, wherein the proportion of the structural unit (c₂) in the copolymer P₂ is from about 50% to about 75% by mole, based on the total number of moles of monomeric units in the copolymer P₂.

10. The method according to claim 1, wherein the monomers which the structural unit (a₁) and the structural unit (a₂) are derived from are different; wherein the monomers which the structural unit (b₁) and the structural unit (b₂) are derived from are different; and wherein the monomers which the structural unit (c₁) and the structural unit (c₂) are derived from are different.

11. The method according to claim 1, wherein the carboxylic acid is independently selected from the group consisting of acrylic acid, methacrylic acid, crotonic acid, 2-butyl crotonic acid, cinnamic acid, maleic acid, maleic anhydride, fumaric acid, itaconic acid, itaconic anhydride, tetraconic acid, 2-ethylacrylic acid, isocrotonic acid, cis-2-pentenoic acid, trans-2-pentenoic acid, angelic acid, tiglic acid, 3,3-dimethyl acrylic acid, 3-propyl acrylic acid, trans-2-methyl-3-ethyl acrylic acid, cis-2-methyl-3-ethyl acrylic acid, 3-isopropyl acrylic acid, trans-3-methyl-3-ethyl acrylic acid, cis-3-methyl-3-ethyl acrylic acid, 2-isopropyl acrylic acid, trimethyl acrylic acid, 2-methyl-3,3-diethyl acrylic acid, 3-butyl acrylic acid, 2-butyl acrylic acid, 2-pentyl acrylic acid, 2-methyl-2-hexenoic acid, trans-3-methyl-2-hexenoic acid, 3-methyl-3-propyl acrylic acid, 2-ethyl-3-propyl acrylic acid, 2,3-diethyl acrylic acid, 3,3-diethyl acrylic acid, 3-methyl-3-hexyl acrylic acid, 3-methyl-3-tert-butyl acrylic acid, 2-methyl-3-pentyl acrylic acid, 3-methyl-3-pentyl acrylic acid, 4-methyl-2-hexenoic acid, 4-ethyl-2-hexenoic acid, 3-methyl-2-ethyl-2-hexenoic acid, 3-tert-butyl acrylic acid, 2,3-dimethyl-3-ethyl acrylic acid, 3,3-dimethyl-2-ethyl acrylic acid, 3-methyl-3-isopropyl acrylic acid, 2-methyl-3-isopropyl acrylic acid, trans-2-octenoic acid, cis-2-octenoic acid, trans-2-decenoic acid, α-acetoxyacrylic acid, β-trans-aryloxyacrylic acid, α-chloro-β-E-methoxyacrylic acid, and combinations thereof.

12. The method according to claim 1, wherein the amide group-containing monomer is independently selected from the group consisting of acrylamide, methacrylamide, N-methyl methacrylamide, N-ethyl methacrylamide, N-n-propyl methacrylamide, N-isopropyl methacrylamide, isopropyl acrylamide, N-n-butyl methacrylamide, N-isobutyl methacrylamide, N,N-dimethyl acrylamide, N,N-dimethyl methacrylamide, N,N-diethyl acrylamide, N,N-diethyl methacrylamide, N-methylol methacrylamide, N-(methoxymethyl)methacrylamide, N-(ethoxymethyl)methacrylamide, N-(propoxymethyl)methacrylamide, N-(butoxymethyl)methacrylamide, N,N-dimethylaminopropyl methacrylamide, N,N-dimethylaminoethyl methacrylamide, N,N-dimethylol methacrylamide, diacetone methacrylamide, diacetone acrylamide, methacryloyl morpholine, N-hydroxyl methacrylamide, N-methoxymethyl acrylamide, N-methoxymethyl methacrylamide, N,N′-methylene-bis-acrylamide, N-hydroxymethyl acrylamide, and combinations thereof.

13. The method according to claim 1, wherein the nitrile group-containing monomer is independently selected from the group consisting of acrylonitrile, α-halogenoacrylonitrile, α-alkylacrylonitrile, α-chloroacrylonitrile, α-bromoacrylonitrile, α-fluoroacrylonitrile, methacrylonitrile, α-ethylacrylonitrile, α-isopropylacrylonitrile, α-n-hexylacrylonitrile, α-methoxyacrylonitrile, 3-methoxyacrylonitrile, 3-ethoxyacrylonitrile, α-acetoxyacrylonitrile, α-phenylacrylonitrile, α-tolylacrylonitrile, α-(methoxyphenyl)acrylonitrile, α-(chlorophenyl)acrylonitrile, α-(cyanophenyl)acrylonitrile, vinylidene cyanide, and combinations thereof.

14. The method according to claim 1, wherein the aqueous solvent is water, and wherein the proportion of water in the non-solid portion of the cathode slurry is more than 50%.

15. The method according to claim 14, wherein the aqueous solvent comprises a minor component in addition to water; wherein the minor component is selected from the group consisting of methanol, ethanol, isopropanol, n-propanol, tert-butanol, n-butanol, 1,2-butanediol, 1,3-butanediol, 1,4-butanediol, 2,3-butanediol, ethylene glycol, propylene glycol, glycerol, acetone, dimethyl ketone, methyl ethyl ketone, ethyl acetate, isopropyl acetate, propyl acetate, butyl acetate, 1,4-dioxane, diethyl ether, methyl tert-butyl ether, cyclopentyl methyl ether, tetrahydrofuran, 2-methyl tetrahydrofuran, acetonitrile, dimethyl sulfoxide, sulfolane, nitromethane, propylene carbonate, ethylene carbonate, dimethyl carbonate, pyridine, acetaldehyde, formic acid, acetic acid, propanoic acid, butyric acid, γ-valerolactone, furfuryl alcohol, methyl lactate, ethyl lactate, diethanolamine, dimethylacetamide, dimethylformamide, N-methylpyrrolidone, dihydrolevoglucosenone, N,N′-dimethylpropyleneurea, dimethyl isosorbide, and combinations thereof; and wherein the volume ratio of water to the minor component in the aqueous solvent is from about 51:49 to about 99:1.

16. The method according to claim 1, wherein the solid content of the cathode slurry is from about 40% to about 80% by weight, based on the total weight of the cathode slurry; wherein the proportion of the copolymer P₁ and the copolymer P₂ in the cathode slurry are each independently from about 0.5% to about 3.5% by weight, based on the solid content of the cathode slurry; and wherein the proportion of the sum of the copolymer P₁ and the copolymer P₂ in the cathode slurry is at most 5% by weight, based on the solid content of the cathode slurry.

17. The method according to claim 1, wherein the cathode active material is selected from the group consisting of LiCoO₂, LiNiO₂, LiNi₁₋ₓ(M₁)ₓO₂, LiNiₓMn_{y}O₂, LiCoₓNi_{y}O₂, Li_{1+z}NiₓMn_{y}Co_{1-x-y}O₂, LiNiₓCo_{y}Al_{z}O₂, LiV₂O₅, LiTiS₂, LiMoS₂, LiMnO₂, LiCrO₂, LiMn₂O₄, Li₂MnO₃, LiFeO₂, LiM₂PO₄, Li₁₊ₐNi_{b}Mn_{c}CO_{d}Al_{(1-b-c-d)}O₂, Li₃V₂(PO₄)₃, LiVPO₄F, LiNiₓMnₑO₄, LiNi_{0.92}Mn_{0.04}Co_{0.04}O₂, and combinations thereof, wherein 0.1≤x≤0.9; 0≤y≤0.9; 0≤z≤0.4; −0.2≤a≤0.2; 0≤b<1; 0≤c<1, 0≤d<1; 0≤e≤2; and b+c+d≤1; M₁ is selected from the group consisting of Co, Mn, Al, Fe, Ti, Ga, Mg, and combinations thereof; and M₂ is selected from the group consisting of Fe, Co, Ni, Mn, Al, Mg, Zn, Ti, La, Ce, Sn, Zr, Ru, Si, Ge, and combinations thereof.

18. The method according to claim 1, wherein the proportion of the cathode active material in the cathode slurry is from about 75% to about 98% by weight, based on the solid content of the cathode slurry.

19. The method according to claim 1, wherein step 1) further comprises dispersing a conductive agent in addition to the binder composition A and the cathode active material in the aqueous solvent to form the first mixture.

20. The method according to claim 19, wherein the conductive agent is selected from the group consisting of natural graphite particulate, synthetic graphite particulate, hard carbon, soft carbon, mesocarbon microbeads, carbon, carbon black, graphite, expanded graphite, graphene, graphene nanoplatelets, carbon fibers, carbon nano-fibers, graphitized carbon flake, carbon tubes, carbon nanotubes, activated carbon, Super P, KS6, vapor grown carbon fibers, mesoporous carbon, and combinations thereof; and wherein the proportion of the conductive agent in the cathode slurry is from about 1% to about 20% by weight, based on the solid content of the cathode slurry.
